(19) United States
(12) Patent Application Publication
(10) Pub. No.: US 2018/0123140 A1
(43) Pub. Date: May 3, 2018

(54) N-DOPED CARBON NANOMATERIALS AS CATALYSTS FOR OXYGEN REDUCTION REACTION IN ACIDIC FUEL CELLS

(71) Applicant: Case Western Reserve University, Cleveland, OH (US)

(72) Inventor: Liming Dai, (US)

(21) Appl. No.: 15/553,389

(22) PCT Filed: Feb. 25, 2016
(86) PCT No.: PCT/US16/19460

§ 371 Date: Aug. 24, 2017

Related U.S. Application Data
(60) Provisional application No. 62/120,675, filed on Feb. 25, 2015.

(51) Int. Cl. H01M 4/96; H01M 8/0258; H01M 8/1004; H01M 8/2465

(52) U.S. Cl. CPC H01M 4/96; H01M 8/0258; H01M 2008/1095; H01M 8/2465; H01M 8/1004

(57) ABSTRACT

Provided is a membrane electrode assembly and a fuel cell comprising such assemblies. The membrane electrode assembly comprises a polymer electrolyte membrane disposed between an anode and a cathode, the cathode comprising a metal-free, heteroatom doped carbon based material. The metal-free, heteroatom doped carbon based material may include heteroatom doped carbon nanotubes, e.g., heteroatom doped vertically aligned carbon nanotubes. The metal-free, heteroatom doped carbon based material can be any graphitic or partially graphitized carbons, which may also be chosen from heteroatom doped graphene material. The heteroatom doped graphene material may be a composite of heteroatom doped graphene and carbon nanotubes, and optionally comprises conductive carbon particles.

### CROSS-REFERENCE TO RELATED APPLICATIONS

The present application claims priority to and the benefit of U.S. Provisional Application No. 62/120,675 titled “N-Doped Carbon Nanomaterials as Catalysts for Oxygen Reduction Reaction in Acidic Fuel Cells,” filed on Feb. 25, 2015, the disclosure of which is incorporated herein by reference in its entirety.

### STATEMENT OF GOVERNMENT SUPPORT

This invention was made with government support under NSF-AIR (IIP1343270) and NSF-CMMI-1266295 awarded by the National Science Foundation. The government has certain rights in the invention.

### FIELD

The present technology relates to low cost, efficient, and durable catalysts for oxygen reduction reaction (ORR).

### BACKGROUND

The molecular oxygen reduction reaction (ORR) is important to many fields, such as energy conversion (e.g., fuel cells, metal-air batteries, solar cells), corrosion, and biology. K. P. Gong, F. Du, Z. H. Xia, M. Durstock, L. M. Dai, Nitrogen-doped carbon nanotube arrays with high electrocatalytic activity for oxygen reduction. Science 323, 760-764 (2009); J. L. Shui, N. K. Karan, M. Balasubramanian, S. Y. Li, D. J. Liu, Fe/N/C composite in Li—O₂ battery: studies of catalytic structure and activity toward oxygen evolution reaction. J. Am. Chem. Soc. 134, 16654-16661 (2012). For fuel cells to generate electricity by electrochemically reducing oxygen and oxidizing fuel into water, cathodic oxygen reduction plays an essential role in producing electricity and is a key limiting factor on the fuel cell performance. S. Basu, Recent trends in fuel cell science and technology. (Springer; Anamaya, New York New Delhi, 2007), viii, 375 p; H. A. Gasteiger, S. S. Kocha, B. Sompalli, F. T. Wagner, Activity benchmarks and requirements for Pt, Pt-alloy, and non-Pt oxygen reduction catalysts for PEMFCs. Appl. Catal. B-Environ. 56, 9-35 (2005); F. Jaouen et al., Cross-laboratory experimental study of non-noble-metal electrocatalysts for the oxygen reduction reaction. ACS Appl. Mater. Inter. 1, 1623-1639 (2009). To construct fuel cells of practical significance, efficient catalysts are required to promote the ORR at cathode. A. J. Appleby, Electrocatalysis of aqueous dioxygen reduction. J. Electroanal. Chem. 357, 117-179 (1993); R. Adzic, Recent advances in the kinetics of oxygen reduction in electrocatalysts. (Wiley-VCH, New York, 1998); P. Somasundaran, Encyclopedia of surface and colloid science. (Taylor & Francis, New York, 2^{nd} ed., 2006). Traditionally, platinum has been regarded as the best catalyst for ORR in fuel cells, though still suffered multiple drawbacks, including its susceptibility to time-dependent drift, MeOH-crossover and CO-poisoning effects. H. A. Gasteiger, S. S. Kocha, B. Sompalli, F. T. Wagner, Activity benchmarks and requirements for Pt, Pt-alloy, and non-Pt oxygen reduction catalysts for PEMFCs. Appl. Catal. B-Environ. 56, 9-35 (2005); M. K. Debe, Electrocatalyst approaches and challenges for automotive fuel cells. Nature 486, 43-51 (2012). However, the large-scale practical application of fuel cells cannot be realized if the expensive platinum-based electrocatalysts for ORR cannot be replaced by other efficient, low cost, and durable electrodes.

### SUMMARY

The current invention relates to low cost, efficient, and durable catalysts for oxygen reduction reaction (ORR). The availability of low cost, efficient and durable catalysts for ORR is a prerequisite for commercialization of the fuel cell technology. It has now been found that rationally-designed, metal-free, heteroatom doped, e.g., nitrogen-doped, carbon nanotubes and their graphene composites exhibit significantly better long-term operational stabilities and comparable gravimetric power densities with respect to the best NPMC in acidic PEM cells. However, the large-scale practical application of metal-free, doped carbon-based materials in more popular acidic polymer electrolyte membrane (PEM) fuel cells has previously remained elusive because such materials are often found to be less effective in acidic electrolytes and attempts have not been made for a single PEM cell test. The present invention provides a membrane electrode design that may reduce or remove the bottlenecks to translate low-cost, metal-free, carbon-based ORR catalysts to commercial reality, and opens avenues for clean energy generation from affordable and durable fuel cells.

In one aspect, the present invention provides a membrane electrode assembly comprising a polymer membrane electrolyte layer having a first face and a second face; an anode layer disposed on a first face of the polymer membrane electrolyte layer; and a cathode layer disposed on the second face of the polymer membrane electrolyte layer, the cathode layer comprising a catalyst material comprising a metal-free, heteroatom doped carbon based material.

In one embodiment, the heteroatom doped carbon based material comprises heteroatom doped carbon nanotubes.

In one embodiment, the heteroatom is chosen from nitrogen, boron, phosphorous, sulfur, iodine, bromine, chlorine, fluorine, a defect, or a combination of two or more thereof.

In one embodiment, the heteratom is nitrogen.

In one embodiment, the heteroatom doped carbon nanotubes are nitrogen-doped vertically aligned carbon nanotubes.

In one embodiment, the heteroatom doped carbon based material comprises heteroatom doped graphitic material.

In one embodiment, the graphitic material is chosen from graphite, graphene, highly ordered pyrolytic graphite (HOPG), fullerene, or a combination of two or more thereof.

In one embodiment, the heteroatom doped carbon based material comprises a composite of heteroatom doped graphene and carbon nanotubes.

In one embodiment, the heteroatom is chosen from nitrogen, boron, phosphorous, sulfur, iodine, bromine, chlorine, fluorine, a defect, or a combination of two or more thereof.

In one embodiment, the heteroatom is nitrogen.

In one embodiment, the carbon nanotubes in the composite are chosen from non-aligned carbon nanotubes, vertically aligned carbon nanotubes, or a combination thereof.

In one embodiment of the membrane electrode assembly according to any previous embodiment, the heteroatom doped carbon based material further comprises conductive carbon particles.

In one embodiment, the conductive carbon particles are chosen from ketjen black, acetylene black, oil furnace black, thermal black, channel black, or a combination of two or more thereof.

In one embodiment of the membrane electrode assembly according to any previous embodiment, the assembly comprises a first gas diffusion layer disposed on the anode layer, and a second gas diffusion layer disposed on the cathode layer.

In another aspect, the present invention provides an electrochemical device comprising a fuel cell comprising the membrane electrode assembly according to any of the previous embodiments.

In one embodiment, the electrochemical device comprises a plurality of the fuel cells connected in electrical series.

In one embodiment, the electrochemical device comprises at least one bipolar plate disposed between adjacent fuel cells, the bipolar plate having oxygen flow channels and hydrogen flow channels.

### BRIEF DESCRIPTION OF THE DRAWINGS

FIGS. 1A-1E depict fabrication of membrane electrode assembly (MEA) of vertically-aligned N-doped carbon nanotubes (VA-NCNT) arrays and its performance in a PEM fuel cell. (FIG. 1A) Schematic drawings for the fabrication of membrane electrode assembly (MEA) from VA-NCNT arrays (0.16 mg cm²) and the electrochemical oxidation to remove residue Fe. (FIG. 1B) A typical SEM image of the VA-NCNT array. (FIG. 1C) A digital photo image of the used MEA after durability test with the cross-section SEM images shown in the inserts. (FIG. 1D) Polarization curves as the function of the areal current density after accelerated degradation by repeatedly scanning the cell from OCV to 0.1 V at the rate of 10 mA s⁻¹. (FIG. 1E) Polarization and power density as the function of the gravimetric current density. Cathode catalyst loading 0.16 mg cm⁻², Nafion/VA-NCNT=1/1. H₂/O₂: 80° C., 100% RH, back pressures 2 bar.

FIGS. 2A-2H depict morphological features of the N-G-CNT electrodes with and without the addition of carbon black. (FIGS. 2A and 2B) Cross-section SEM images of the densely packed catalyst layer of N-G-CNT/Nafion (0.5/0.5 mg cm⁻²), and (FIGS. 2C and 2D) porous catalyst layer of N-G-CNT/KB/Nafion (0.5/2/2.5 mg cm²). Arrows in (FIG. 2D) indicate the parallelly separated N-G-CNT sheets with inter-dispersed porous KB agglomerates. (FIG. 2E) BET surface areas and (FIG. 2F) pore volume distributions of a piece of 5 cm² GDL, GDL with KB (2 mg cm²), GDL with N-G-CNT (0.5 mg cm⁻²) and GDL with N-G-CNT/KB (0.5/2 mg cm⁻²) as indicated in the figures. (FIGS. 2G and 2H) Schematic drawings of the MEA catalyst layer cross-section, showing O₂ efficiently diffused through the carbon black separated N-G-CNT sheets (FIG. 2G), but not the densely packed N-G-CNT sheets (FIG. 2H).

FIGS. 3A-3D depict electrocatalytic activities of the carbon-based metal-free catalysts in half cell tests. (FIG. 3A) CVs of the N-G-CNT in O₂- or N₂-saturated 0.1 M KOH. (FIG. 3B) LSV curves of the N-G-CNT compared with Pt/C (20%) electrocatalyst by RRDE in O₂-saturated 0.1 M KOH solution at scan rate of 10 mV s⁻¹ and a rotation speed of 1600 rpm. LSV curves of the N-G and N-CNT compared with the N-G-CNT in O₂-saturated: (FIG. 3C) 0.1 M KOH; (FIG. 3D) 0.1 M HClO₄.

FIGS. 4A-4C depict power and durability performance of N-G-CNT with the addition of KB in PEM fuel cells. (FIG. 4A) Polarization curves of N-G-CNT with loadings: 2, 0.5 or 0.15 mg cm⁻² plus KB 2 mg cm⁻² for each cathode. The weight ratio of (N-GCNT/KB)/Nafion=1/1. (FIG. 4B) Cell polarization and power density as the function of gravimetric current for the N-G-CNT/KB (0.5/2) mg cm⁻² with the weight ratio of (N-GCNT/KB)/Nafion=1/1. (FIG. 4C) Durability of the metal-free N-G-CNT in a PEM fuel cell measured at 0.5 V, compared with a Fe/N/C catalyst. Catalyst loading of N-G-CNT/KB: 0.5 mg cm⁻², and Fe/N/C: 0.5 and 2 mg cm⁻². Test condition: H₂/O₂, 80° C., 100% RH, back pressures 2 bar.

FIGS. 5A-5D depict characterization of VA-NCNTs. (FIG. 5A) A TEM image of purified individual CNTs. (FIG. 5B) TGA of the as-synthesized VA-NCNT, showing increased weights on two plateaus over 50-500° C. due to the residual Fe being oxidized on the surface and in the inner part of the CNTs, respectively, as well as about 20 wt. % residue over 600° C. The purified NCNTs gradually lost 20% weight up to 500° C. due to the loss of adsorbed acidic groups generated during the purification process. Above 600° C., the purified NCNT material was completely burned off, indicating no metal residue left. (FIG. 5C) Raman spectrum showing highly graphitic character with I_{D}/I_{G}=0.91. (FIG. 5D) XPS spectrum indicating 2.9% N content in the purified VA-NCNTs, including 45% pyridinic-N, 15% pyrrolic-N, 21% graphitic-N, and 19% from NO.

FIGS. 6A-6F depicts electrocatalytic activities of the VA-NCNT catalyst in alkaline electrolyte (O₂-saturated 0.1 M KOH) by half-cell tests. (FIG. 6A) LSV curves, (FIG. 6B) Tafel plot and (FIG. 6C) electron-transfer number of the VA-NCNT compared with Pt/C (20%) electrocatalyst by RRDE at scan rate of 10 mV s⁻¹ and a rotation speed of 1600 rpm. (FIG. 6D) Long time stability, and tolerance to (FIG. 6E) carbon monoxide and (FIG. 6F) methanol of metal-free catalyst VA-NCNT compared with Pt/C (20%) electrocatalyst at 0.5 V (vs. RHE). CO (flow 100 mL s⁻¹) was injected into the electrolytes (100 mL) at the time of 200 s and stopped at the 500 s. Methanol (10 mL) was injected into the electrolytes (100 mL) at the time of 200 s.

FIGS. 7A-7F depicts. electrocatalytic activities of the VA-NCNT catalyst in acidic electrolyte (O₂-saturated 0.1 M HClO₄) by half-cell tests. (FIG. 7A) LSV curves, (FIG. 7B) Tafel plot and (FIG. 7C) electron-transfer number of the VA-NCNT compared with Fe/N/C and Pt/C (20%) electrocatalysts by RRDE at scan rate of 10 mV s⁻¹ and a rotation speed of 1600 rpm. (FIG. 7D) Long time stability, and tolerance to (FIG. 7E) carbon monoxide and (FIG. 7F) methanol of metal-free catalyst VA-NCNT compared with Fe/N/C and Pt/C (20%) electrocatalysts at 0.5 V (vs. RHE). CO (flow 100 mL s⁻¹) was injected into the electrolytes (100 mL) at the time of 200 s and stopped at the 500 s. Methanol (10 mL) was injected into the electrolytes (100 mL) at the time of 200 s.

FIGS. 8A-8C depict typical cross-section SEM images of the GDL with the MEA of VA-NCNTs as the cathode catalyst layer, Nafion membrane (N211) as the separator, and Pt/C as the anode. A piece of carbon paper with a carbon black layer (ElectroChem Inc, Carbon Micro-porous Layer (CMPL)) was used as the gas diffusion layer (GDL).

FIGS. 9A-9F (FIG. 9A) SEM and (FIG. 9B) TEM images of N-CNT bundles. (FIG. 9C) SEM and (FIG. 9D) TEM images of the N-G-CNT sheets. Top view of (FIG. 9E) the N-G-CNT and (FIG. 9F) the N-G films made by dispersing the materials in isoprapanol uniformly, droping the dispersions onto two Al foils and then drying the films. The N-G-CNT sheets are more rigided and against restacking better than the N-G sheets.

FIGS. 10A-10F depict typical cross-section SEM images of the GDLs with the MEAs of (FIGS. 10A-10C) N-G-CNT (2 mg cm⁻²) and (FIGS. 10D-10F) N-G-CNT+KB (0.5+2 mg cm⁻²) as the cathode catalyst layers, respectively. Arrows point to several N-G-CNT sheets separated by KB agglomerates in (FIG. 10F). Nafion membrane (N211) as the separator, and Pt/C as the anode. A piece of carbon paper with a carbon black layer (ElectroChem Inc, Carbon Micro-porous Layer (CMPL)) was used as the gas diffusion layer (GDL).

FIGS. 11A-11B. (FIG. 11A) Tafel plot and (FIG. 11B) Electron-transfer number for the N-G-CNT and Pt/C (20%) as the function of electrode potential by RRDE in oxygen-saturated 0.1 M KOH solution at scan speed of 5 mV s⁻¹ and a rotation speed of 1600 rpm.

FIGS. 12A-12C depict long time stability and tolerance to methanol/carbon monoxide of metal-free catalyst N-G-CNT. (FIG. 12A) The normalized ORR cathodic current-time response of the N-G-CNT and 20% Pt/C in O₂-saturated 0.1 M KOH for 50000 s. The relative ORR cathodic current as the function of time for the N-G-CNT and 20% Pt/C before and after adding (FIG. 12B) 3 M methanol, and (FIG. 12C) CO into the O₂-saturated 0.1 M KOH.

FIGS. 13A-13F depict SEM images of catalyst layer cross-sections used in RDE measurements. (FIGS. 13A and 13D) N-G; (FIGS. 13B and 13E) N-CNT; and (FIGS. 13C and 13F) N-G-CNT. Catalyst layers contain 5 wt. % Nafion binder loaded on the glass carbon electrode.

FIGS. 14A-14F depict electrocatalytic activities of the carbon-based metal-free N-G-CNT catalysts in acidic electrolyte (O₂-saturated 0.1 M HClO₄) by half-cell tests. (FIG. 14A) LSV curves. (FIG. 14B) Tafel plot and (FIG. 14C) electron-transfer number of the N-G-CNT compared with Fe/N/C and Pt/C (20%) electrocatalysts by RDE at scan rate of 10 mV s⁻¹ and a rotation speed of 1600 rpm. (FIG. 14D) Long time stability, and tolerance to (FIG. 14E) carbon monoxide and (FIG. 14F) methanol of metal-free catalyst N-G-CNT compared with Fe/N/C and Pt/C (20%) electrocatalysts at 0.5 V (vs. RHE). CO (flow 100 mL s⁻¹) was injected into the electrolytes (100 mL) at the time of 200 s and stopped at the 500 s. Methanol (10 mL) was injected into the electrolytes (100 mL) at the time of 200 s.

FIGS. 15A-15B depict optimization of a cathode catalyst layer composition. (FIG. 15A) Polarization curve of the N-G-CNT with or without carbon black (KB) at the loading of 2 mg cm⁻² for each catalyst layer composition. The weight ratio of Carbon (N-G-CNT+KB)/Nafion=1/1. (FIG. 15B) The corresponding cell resistances of N-G-CNT and N-G-CNT+KB based catalyst layers. Testing condition for all MEAs are fueled with pure H₂/O₂, under back pressures 2 bar, at 80° C. and 100% RH.

FIGS. 16A-16C depict single cell performance comparison between N-G-CNT and Fe/N/C catalysts at the same catalyst layer composition: catalyst 0.5 mg cm⁻²/KB 2 mg cm⁻²/Nafion 2.5 mg cm⁻². (FIG. 16A) Polarization curves as the function of areal current. (FIG. 16B) Polarization curves as the function of gravimetric current. (FIG. 16C) Power density as the function of gravimetric current. Test condition: H₂/O₂, 80° C., 100% RH, back pressures 2 bar.

FIG. 17 depicts polarization curves of the N-G-CNT and individual components of N-G or N-CNT. Catalyst loadings were (0.5 mg catalyst+2 mg KB) cm². Testing condition for all MEAs are fueled with pure H₂/O₂, under back pressures 2 bar, at 80° C. and 100% RH.

FIG. 18 depicts durability of the catalyst layer composed of metal-free N-G-CNT (2 mg cm²)+KB (2 mg cm²) in a PEM fuel cell measured at 0.5 V. Test condition: H₂/O₂, 80° C., 100% RH, back pressures 2 bar.

FIGS. 19A-19D depict the metal-free character of N-G-CNT catalyst. (FIG. 19A) TGA curve of the N-G-CNT in air, showing no residue above 600° C. (FIG. 19B) Raman spectrum showing I_{D}/I_{G}=1.22. (FIG. 19C) XPS spectrum of the N-G-CNT with no detectable Fe. (FIG. 19D) N1s XPS of N-G-CNT.

The drawings are not to scale unless otherwise noted. The drawings are for the purpose of illustrating aspects and embodiments of the present technology and are not intended to limit the technology to those aspects illustrated therein. Aspects and embodiments of the present technology can be further understood with reference to the following detailed description.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” mean an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

The current invention relates to low cost, efficient, and durable catalysts for oxygen reduction reaction (ORR). The availability of low cost, efficient and durable catalysts for ORR is a prerequisite for commercialization of the fuel cell technology. In particular, the present invention provides a catalyst for use in acidic polymer electrolyte membrane (PEM) fuel cells. It has been found that metal-free, heteroatom doped carbon-based materials may be employed as a catalyst in acidic PEM fuel cells. In particular, it has been found that metal-free, heteroatom doped carbon nanotubes and their graphene composites may exhibit significantly better long-term operational stabilities and comparable gravimetric power densities with respect to the best NPMC in acidic PEM cells. Without being bound to any particular theory, the use of such materials as catalysts in acidic PEM cells may reduce or remove the bottlenecks to translate low-cost, metal-free, carbon-based ORR catalysts to commercial reality, and opens avenues for clean energy generation from affordable and durable fuel cells.

Provided is an electrochemical device comprising a fuel cell employing an acidic electrolyte and having a membrane electrode assembly comprising a positive electrode, a negative electrode, and a separator containing an electrolyte. In fuel cells employing acidic electrolytes, e.g., a hydrogen fuel cell, the electron pathway generally involves the following reactions:

Cathode side half-reaction(acidic electrolyte): O₂+4e⁻→2O²⁻

Anode side half-reaction(acidic electrolyte): 2H₂→4H⁺+4e⁻

Net reaction: 2H₂+O₂→4H⁺+2O²⁻→2H₂O

It will be appreciated that other fuels and oxidants may be employed in the fuel cells. The four-electron pathway illustrated above is generally referred to, regardless of the fuel, as an oxygen-reduction reaction.

The polymer electrolyte membrane (PEM) (also known as an ion conductive membrane (ICM)), functions as a solid electrolyte. One face of the PEM is in contact with an anode electrode layer and the opposite face is in contact with a cathode electrode layer. In typical use, protons are formed at the anode via hydrogen oxidation and transported across the PEM to the cathode to react with oxygen, causing electrical current to flow in an external circuit connecting the electrodes. Each electrode layer includes electrochemical catalysts. The catalyst in the anode layer is not particularly limited and any convention anode catalyst now known or later discovered may be employed. In embodiments, the anode catalyst may be chosen from, for example, Pt/C electrodes.

The catalyst for the cathode layer employs a metal-free, heteroatom doped carbon-based material, and is described further herein. The PEM forms a durable, non-porous, electrically non-conductive mechanical barrier between the reactant gases, yet it also passes H⁺ ions readily. The membrane electrode assembly may include diffusion layers (GDL's) to facilitate gas transport to and from the anode and cathode electrode materials and conduct electrical current. The GDL is both porous and electrically conductive, and is typically composed of carbon fibers. The GDL may also be called a fluid transport layer (FTL) or a diffuser/current collector (DCC). In some embodiments, the anode and cathode electrode layers are applied to GDL's and the resulting catalyst-coated GDL's sandwiched with a PEM to form a five-layer MEA. The five layers of a five-layer MEA are, in order: anode GDL, anode electrode layer, PEM, cathode electrode layer, and cathode GDL. In other embodiments, the anode and cathode electrode layers are applied to either side of the PEM, and the resulting catalyst-coated membrane (CCM) is sandwiched between two GDL's to form a five-layer MEA.

In the present membrane electrode assemblies and electrochemical devices employing such assemblies, the positive electrode, e.g., the cathode, comprises a catalytic layer comprising a metal-free, heteroatom doped carbon-based material. The metal-free, heteroatom doped carbon-based material comprise a carbon-based material of interest doped with a heteroatom such as, for example, nitrogen, boron, phosphorous, sulfur, iodine, bromine. chlorine, fluorine, or any other heteroatoms or defects that can be doped into carbon structures or a combination of two or more thereof. The carbon based material is provided as any suitable dimensional structure (e.g., any 1D-3D structure). Examples of suitable carbon-based materials include, but are not limited to, carbon nanotubes, carbon sheets (e.g., graphene sheets), and the like. In the heteroatom doped carbon-based materials, at least a portion of the carbon sites in the structure are filled with a heteroatom instead of with carbon atoms such that the portion of carbon sites so filled with the heteroatom are detectable by common analytical means including, for example, x-ray photoelectric spectroscopy (XPS).

As used herein, the term heteroatom also encompasses and includes defects, e.g., crystalline defects, within the crystal lattice of the carbon-based material. It will be appreciated that graphitic material generally comprises planar sheets of sp² hybridized carbon that form an essentially hexagonal lattice. The graphitic may contain defects that prevent them from being in the form of a perfect hexagonal lattice and may, for example, contain sp³hybridized carbons or heteroatoms. The term “crystalline defects” refers to sites in graphitic material where there is a lattice distortion in at least one carbon ring. A “lattice distortion” means any distortion of the crystal lattice of graphitic material. A lattice distortion may include any displacements of atoms because of inelastic deformation, the presence of 5 and/or 7 member carbon rings, or a chemical interaction followed by change in hybridization of carbon atom bonds. It will be appreciated by those skilled in the art that at defect sites in carbon nanotubes, where, for example, the graphitic plane fails to extend fully around the fibril, there are carbon atoms analogous to the edge carbon atoms of a graphite plane. At defect sites, edge or basal plane carbons of lower, interior layers of the nanotube may be exposed. The term surface carbon includes all the carbons, basal plane and edge, of the outermost layer of the nanotube, as well as carbons, both basal plane and/or edge, of lower layers that may be exposed at defect sites of the outermost layer. The edge carbons are reactive and must contain some heteroatom or group to satisfy carbon valency.

In one embodiment, the heteroatom doped carbon based material comprises heteroatom doped carbon nanotubes. The heteroatom doped nanotubes may comprise a plurality of vertically aligned carbon nanotubes that are doped with a heteroatom. The heteroatom may be chosen from nitrogen, boron, phosphorous, sulfur, iodine, bromine, chlorine, fluorine, or any other heteroatoms and even defects that can be doped into carbon structures, or a combination of two or more thereof. In embodiments, the heteroatom is nitrogen. “Vertically aligned carbon nanotubes” may refer to nanotubes wherein a plurality of individual nanotubes are substantially parallel to each other and are substantially perpendicular to a body supporting the individual nanotubes.

In one embodiment, the heteroatom doped carbon based material is a graphitic material doped with a heteroatom. As used herein, the term “graphitic material” may refer to a material having a graphitic surface with hexagonal arrangement of carbon atoms. The graphitic material may include any graphitic material having the graphitic surface, regardless of physical, chemical or structural properties. Examples of the graphitic material may include materials having a surface with hexagonal arrangement of carbon atoms, such as graphite, graphene, highly ordered pyrolytic graphite (HOPG), fullerene, etc. The heteroatoms in the graphitic material doped with the heteroatom may be chosen from nitrogen, boron, phosphorous, sulfur, iodine, bromine. chlorine, fluorine, or any other heteroatoms and even defects that can be doped into carbon structures, or a combination of two or more thereof. The graphitic material may be provided in any suitable form including, for example, a sheet, foil, ribbon, etc. In the embodiments where the heteroatom doped carbon based material is a graphitic material doped with a heteroatom, the composition further comprises particulate matter or agglomerates disposed within the graphitic material. Without being bound to any particular theory, the particulate matter or agglomerates may help to maintain the porosity of the graphitic material after processing. In particular, in forming the MEA, the graphitic sheets are compressed and the graphitic material is closely stacked, which may inhibit the transport of oxygen in the system and slow the ORR reaction. In on embodiment, the particulate matter is chosen from a carbon based material such as carbon black. The carbon black particles may be chosen from conductive carbon black particles including, but not limited to, ketjen black, acetylene black, oil furnace black, thermal black, channel black, or a combination of two or more thereof.

In one embodiment, the graphitic material doped with a heteroatom comprises a composite of a graphitic material doped and carbon nanotubes, where the graphitic material and/or the carbon nanotubes are doped with a heteroatom, and the composite further comprises particulate matter or agglomerates, e.g., carbon black, disposed in the composite.

The size or concentration of the particulate matter or agglomerates is not particularly limited. As discussed above, the particulate matter/agglomerates provides spacing between the layers of the graphitic material, which may assist with oxygen and electrolyte flow. Therefore, it may be desirable to provide larger particles to provide this effect.

Metal-free, heteroatom doped carbon based materials may be prepared by any suitable method. Vertically aligned carbon nanotubes may be prepared, for example, by pyrolyzing a hydrocarbon or a metalorganic compound in the presence of a substrate suitable for growth of carbon nanotubes (e.g., silica). Examples of suitable metalorganic compounds include, but not limited to, for example, ferrocene, iron(II) phthalocyanine (FePc), etc. The compound may be pyrolyzed at, for example, 800-1100° C. During pyrolysis, the heteroatom can be integrated into the nanotubes when a nitrogen based compound is employed as the starting material or by exposing the nanotubes to a suitable source of the heteroatom, e.g., a suitable gaseous source containing the desired heteroatom. Methods of preparing nitrogen-doped carbon nanotubes is disclosed, for example, in K. P. Gong, F. Du, Z. H. Xia, M. Durstock, L. M. Dai, Nitrogen-doped carbon nanotube arrays with high electrocatalytic activity for oxygen reduction. Science 323, 760-764 (2009). Heteroatom doped graphene can be prepared by forming a graphene oxide material, freeze drying the material to form a graphene oxide foam, and annealing the graphene oxide foam under a gas containing the desired heteroatom of interest. Heteroatom doped composites of graphene and carbon nanotubes may be prepared by providing a mixture of graphene oxide and carbon nanotubes. The weight ratio of graphene oxide and carbon nanotubes may be selected as desired and in embodiments is about 1:1. The mixture of graphene oxide and carbon nanotubes may be freeze dried and annealed in the presence of a gas containing the desired heteroatom.

A PEM used in a MEA according to the present invention may comprise any suitable polymer electrolyte. The polymer electrolytes useful in the present invention typically bear anionic functional groups bound to a common backbone, which are typically sulfonic acid groups but may also include carboxylic acid groups, imide groups, amide groups, or other acidic functional groups. The polymer electrolytes useful in the present invention are typically highly fluorinated and most typically perfluorinated. The polymer electrolytes useful in the present invention are typically copolymers of tetrafluoroethylene and one or more fluorinated, acid-functional comonomers. Typical polymer electrolytes include Nafion® (DuPont Chemicals, Wilmington Del.) and Flemion™ (Asahi Glass Co. Ltd., Tokyo, Japan). The polymer electrolyte may be a copolymer of tetrafluoroethylene (TFE) and FSO₂—CF₂CF₂CF₂CF₂—O—CF═CF₂, described in U.S. patent application Ser. Nos. 10/322,254, 10/322,226 and 10/325,278, which are incorporated herein by reference. The polymer typically has an equivalent weight (EW) of 1200 or less, more typically 1100 or less, more typically 1000 or less, and may have an equivalent weight of 900 or less, or 800 or less.

The polymer can be formed into a membrane by any suitable method. The polymer is typically cast from a suspension. Any suitable casting method may be used, including bar coating, spray coating, slit coating, brush coating, and the like. Alternately, the membrane may be formed from neat polymer in a melt process such as extrusion. After forming, the membrane may be annealed, typically at a temperature of 120° C. or higher, more typically 130° C. or higher, most typically 150° C. or higher. The PEM typically has a thickness of less than 50 microns, more typically less than 40 microns, more typically less than 30 microns, and in some embodiments about 25 microns.

An acid electrolyte is dispersed in the polymer electrolyte membrane. The acid electrolyte may be selected from phosphoric acid, sulfuric acid, sulfonic acid, nitric acid, hydrogen chloride, formic acid, or a combination thereof.

In making an MEA, GDL's may be applied to either side of a CCM. The GDL's may be applied by any suitable means. Any suitable GDL may be used in the practice of the present invention. Typically the GDL is comprised of sheet material comprising carbon fibers. Typically the GDL is a carbon fiber construction selected from woven and non-woven carbon fiber constructions. Carbon fiber constructions which may be useful in the practice of the present invention may include: Toray™ Carbon Paper, SpectraCarb™ Carbon Paper, AFN™ non-woven carbon cloth, Zoltek™ Carbon Cloth, and the like. The GDL may be coated or impregnated with various materials, including carbon particle coatings, hydrophilizing treatments, and hydrophobizing treatments such as coating with polytetrafluoroethylene (PTFE).

In use, the MEA according to the present invention is typically sandwiched between two rigid plates, known as distribution plates, also known as bipolar plates (BPP's) or monopolar plates. Like the GDL, the distribution plate must be electrically conductive. The distribution plate is typically made of a carbon composite, metal, or plated metal material. The distribution plate distributes reactant or product fluids to and from the MEA electrode surfaces, typically through one or more fluid-conducting channels engraved, milled, molded or stamped in the surface(s) facing the MEA(s). These channels are sometimes designated a flow field. The distribution plate may distribute fluids to and from two consecutive MEA's in a stack, with one face directing fuel to the anode of the first MEA while the other face directs oxidant to the cathode of the next MEA (and removes product water), hence the term “bipolar plate.” Alternately, the distribution plate may have channels on one side only, to distribute fluids to or from an MEA on only that side, which may be termed a “monopolar plate.” The term bipolar plate, as used in the art, typically encompasses monopolar plates as well. A typical fuel cell stack comprises a number of MEA's stacked alternately with bipolar plates.

Aspects and embodiments of the invention may be further understood in view of the following examples. The examples are for the purpose of illustrating aspects of the invention and are not intended to limit the invention only to those features illustrated in the examples.

### EXAMPLES

### Example 1—Performance Evaluation of VA-NCNTs in PEM Fuel Cells

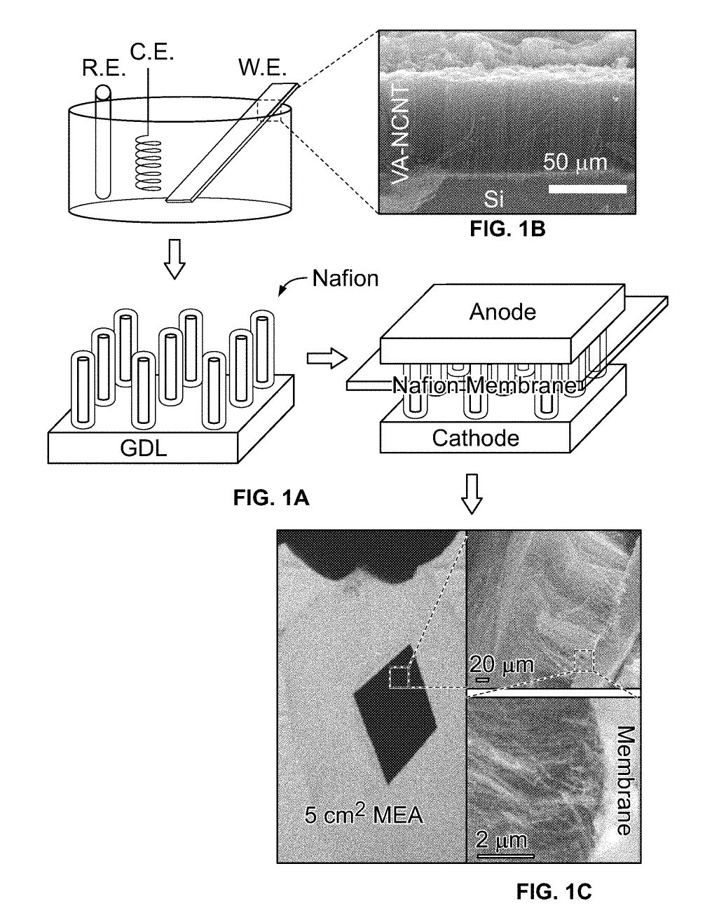

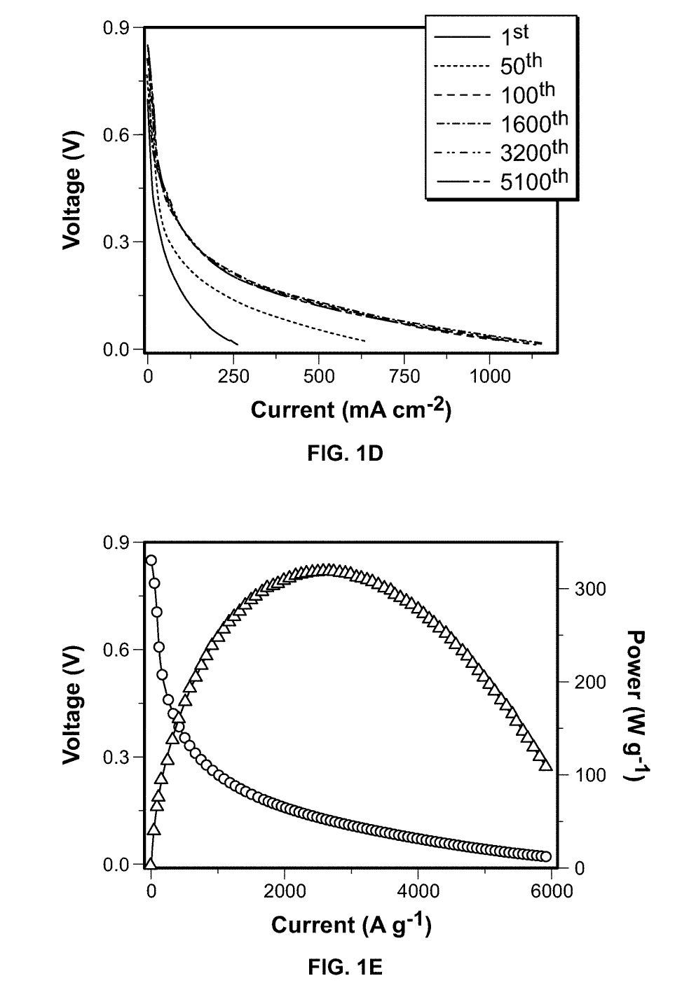

To carry out the performance evaluation of VA-NCNTs in PEM fuel cells, the VA-NCNT arrays (80 μm height, a surface packing density of 0.16 mg cm⁻²) were made into a membrane electrode assembly (MEA) at the highest allowable catalyst loading of 0.16 mg cm⁻². FIG. 1 schematically shows procedures for the MEA preparation (FIG. 1A), along with a typical scanning electron microscopic (SEM) image of the starting VA-NCNT array (FIG. 1B) and a photographic image of the newly-developed MEA (FIG. 1C).

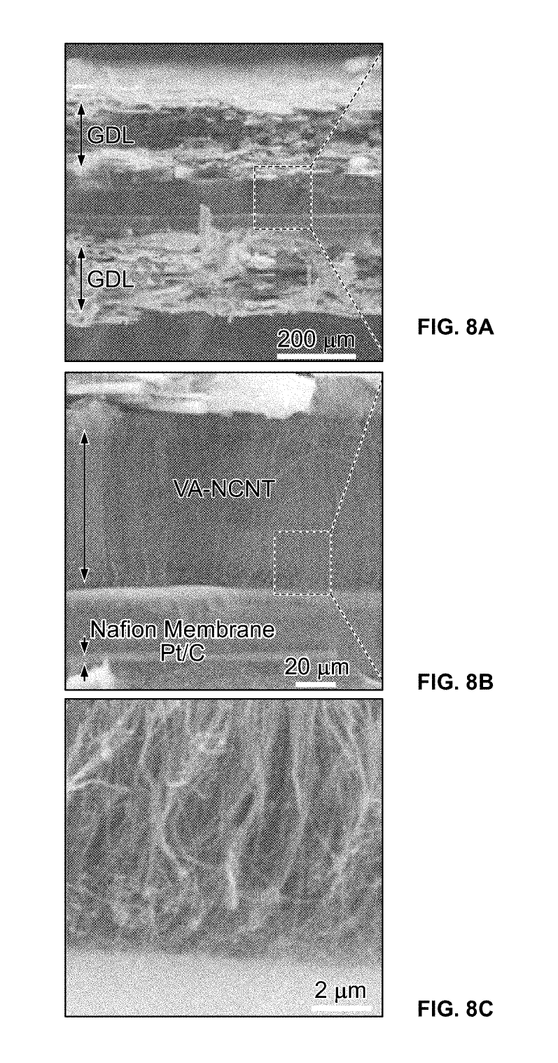

The electrochemical oxidation in H₂SO₄ was performed to remove Fe residue, if any, in the VA-NCNTs made from pyrolysis of iron(II) phthalocyanine, followed by etching off the purified VA-NCNT array from the Si wafer substrate in aqueous HF (10 wt. %), rinsing it copiously with deionized water, transferring it onto a gas diffusion layer (GDL, Carbon Micro-porous Layer (CMPL), ElectroChem Inc.), and drop-coating with a sulfonated tetrafluoroethylene based ionomer “Nafion®” (DuPont) as binder and electrolyte, which was then assembled with a Pt/C-coated GDL as the anode and an intermediate layer of proton conductive membrane (Nafion® N211, DuPont) as the separator (see FIGS. 8A-8C for the MEA cross-section images).

As can be seen in FIGS. 1A-1C and FIGS. 8A-8C, the NCNT ORR catalyst within the MEA thus produced largely retained its vertical alignment.

The resulting MEA containing the VA-NCNT metal-free ORR electrocatalysts was evaluated in an acidic PEM fuel cell operating with the “Nafion®” electrolyte and pure H₂/O₂ gases. The PEM fuel cell was activated after one hundred scanning cycles from open circuit potential (OCV) to ˜0.1 V (FIG. 1D). Surprisingly, a consistent polarization performance was observed over 5100 scanning cycles, indicating a stable electrocatalytic performance even in acid under the harsh working condition. Thus, N—C centers in the carbon-based metal-free catalysts seem to be more stable than the transition metal active sites in NPMCs in PEM fuel cells. The relatively poor polarization performance seen in FIG. 1D for the first tens cycles is, most probably, due to the weak electrode-electrolyte interaction on the as-prepared hydrophobic VA-NCNT electrode, which became hydrophilic upon electrochemical activation during the subsequent polarization cycles (34). For the VA-N-CNT MEA, significantly high gravimetric current densities were observed: 35 A g⁻¹ @ 0.8 V, 145 A g⁻¹ @ 0.6 V and 1550 A g⁻¹ @ 0.2 V (FIG. 1E). As can also be seen in FIG. 1E, the peak power density was 320 W g⁻¹ for VA-NCNT MEA, outperformed or comparable to even the most active NPMC catalysts (Table 1) (11).

TABLE 1

| | | | Peak | | O₂—H₂ | |
|---|---|---|---|---|---|---|
| | Current | Current | power | Catalyst | Back | |
| | @ 0.8 V | @ 0.2 V | density | loading | pressure | |
| Materials | (A g⁻¹) | (A g⁻¹) | (W g⁻¹) | (mg cm⁻²) | (bar) | Ref. |
| FeCo/N/C | 15 | 700 | 200 | 2 | 1.0 | (14) |
| Fe/N/C | 8/100 | 800/2500 | 233/400 | 3.9/0.9 | 0.5 | (11) |
| Fe/N/C | 15 | 325 | 80 | 4 | 1.3 | (45) |
| VA-NCNT | 35 | 1550 | 320 | 0.16 | 1.5 | This work |
| N-G-CNT + KB | 30 | 1500 | 300 | 0.5 | 1.5 | This work |

Table 1 describes the gravimetric activities of various transition metal-derived NPMCs compared with the metal-free VA-NCNT and N-G-CNT+KB in PEM fuel cells. All the data in the table have also been scaled by the electrode surface area.

### Example 2—Evaluation Performance of Graphene-Based Metal-Free ORR Catalysts

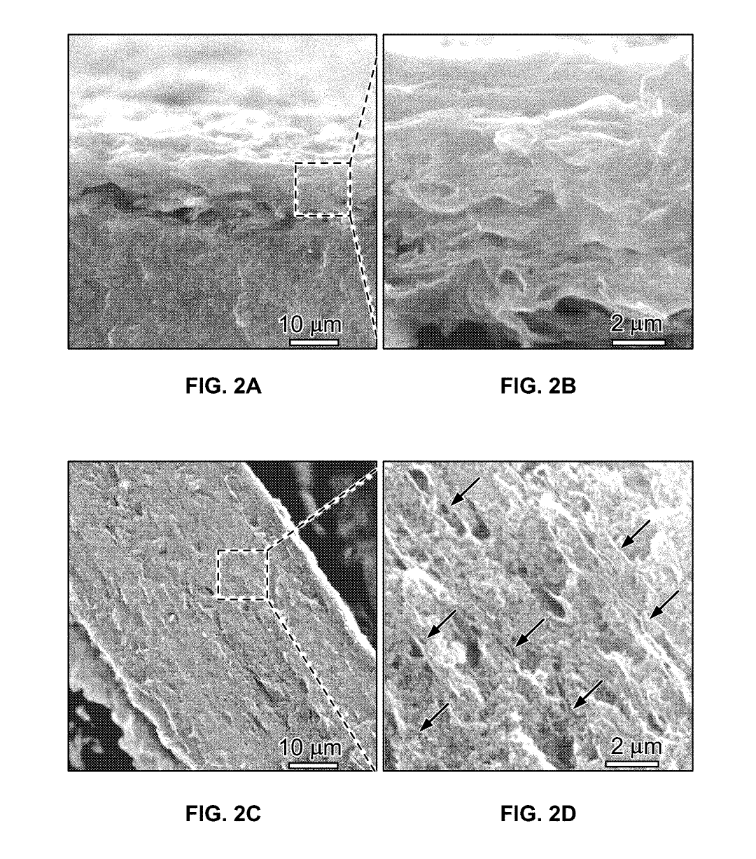

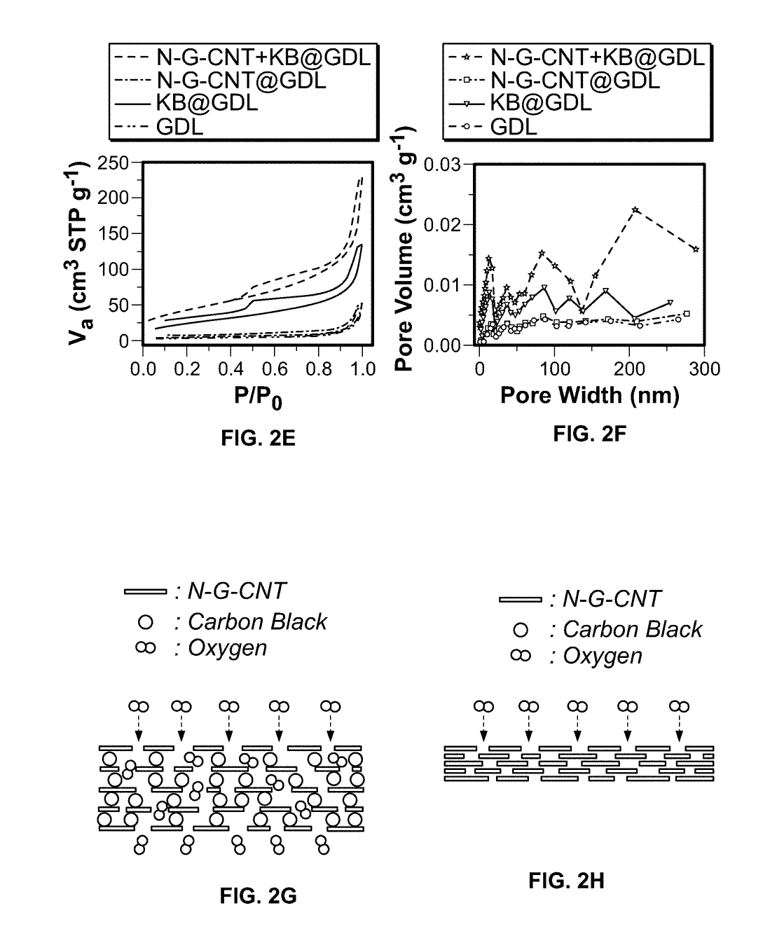

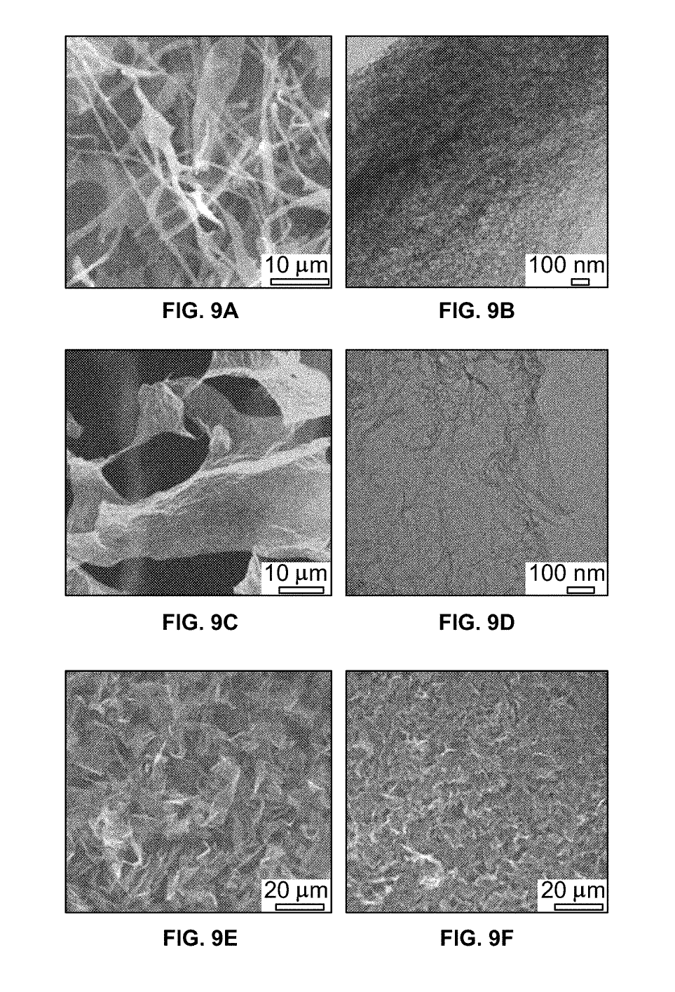

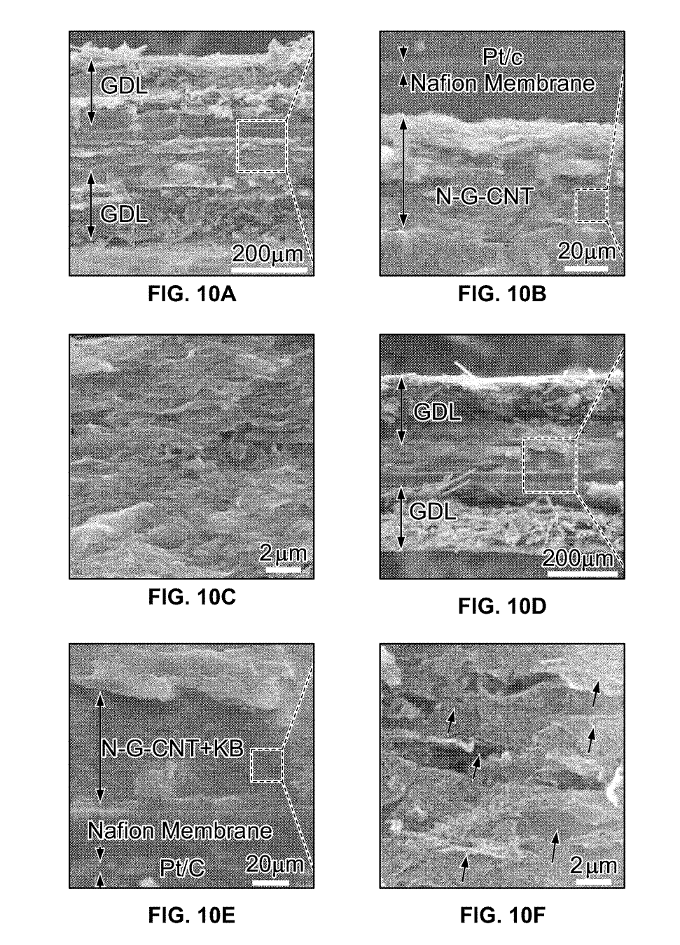

A metal-free GO suspension was prepared by the modified Hummers' method (31), which was then mixed with oxidized CNT suspension, prepared from commercially available nonaligned multiwalled carbon nanotubes (MWCNTs, Baytubes C 150 HP, Bayer MaterialScience) after purification to remove metal residues, to produce metal-free porous N-doped graphene and CNT composites (N-G-CNT) through freeze-drying, followed by annealing at 800° C. in NH₃ for 3 hours (see FIGS. 9A-9F). The N-G-CNT based catalyst ink for MEAs was then prepared by mixing 2.5 mg N-G-CNT catalyst with 10 mg carbon black particles (primary particle radius 34 nm, BET surface area 1270 m² g⁻¹, Ketjenblack® EC-600JD) and 375 mg Nafion solution (5%) in 1.5 mL deionized water and isopropanol mixture (volume ratio=1:2). Thereafter, the ink was sonicated for 10 minutes and stirred overnight, then painted onto a 5 cm² GDL as the cathode electrode and assembled into a MEA with a Pt/C-coated GDL as the anode and an intermediate layer of proton conductive membrane (Nafion® N211, DuPont) as the separator for subsequent testing (FIGS. 10A-10F). Several synergistic effects can arise from the above fabrication process to maximize the utilization of catalyst sites in the N-G-CNT composite: 1) N-G can prevent N-CNTs from the formation of the bundle structure to facilitate the dispersion of N-CNTs by anchoring individual N-CNTs on the graphene sheets via the strong π-π stacking interaction (FIG. 9A-9D); 2) N-CNTs can also effectively prevent the N-G sheets from restacking by dispersing CNTs on the graphene basal plane to make more rigid curved N-G-CNT sheets than the N-G sheets (FIG. 9C-9F); and 3) the addition of carbon black (Ketjenblack®) can not only further separate N-G-CNT sheets in the catalyst layer, but also induce continued porous multichannel pathways between the N-G-CNT sheets for efficient O₂ diffusion (FIG. 2).

A comparison of FIG. 10F with 10C indicates that the introduction of carbon black particles led to a porous network structure for the N-G-CNT/KB catalyst layer, facilitating the O₂ diffusion (cf. FIGS. 2A-D). Brunauer, Emmett and Teller (BET) measurements on the electrodes showed that a 5-cm² porous cathode N-G-CNT/KB@GDL has a surface area of 155 m² g⁻¹ (or 1161 m² g⁻¹ N-G-CNT/KB after taking off the weight of GDL and Nafion), and a significant number of pores from micro- to macro-sizes (FIGS. 2E and 2F). In contrast, a dense cathode N-G-CNT@GDL without interspersed carbon black particles has a surface area as low as 16 cm² g⁻¹ with negligible pore volume. The presence of pores in FIGS. 2C and 2D could facilitate the mass transfer of O₂ gas in the porous N-GCNT/KB catalyst layer (FIG. 2G) with respect to the densely packed N-G-CNT sheets (FIGS. 2A and 2B) without the intercalated carbon black (FIG. 2H).

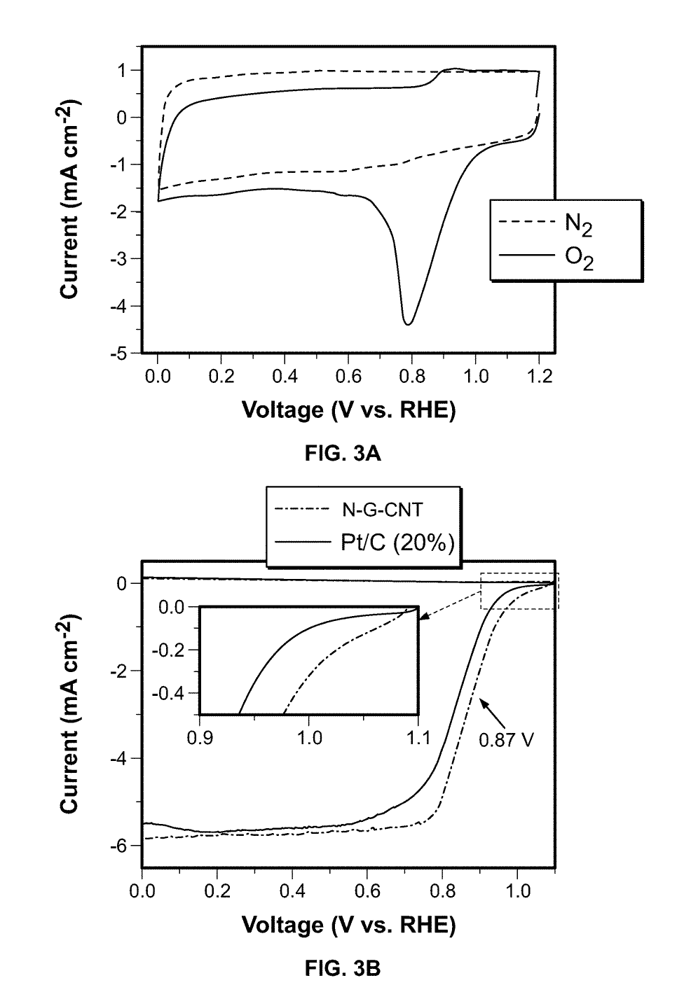

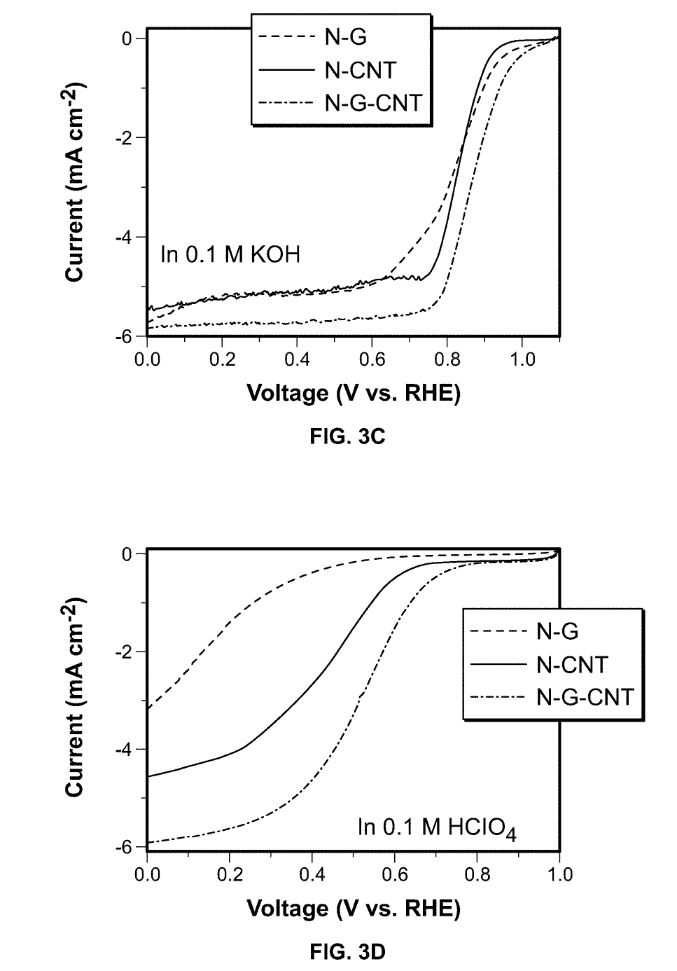

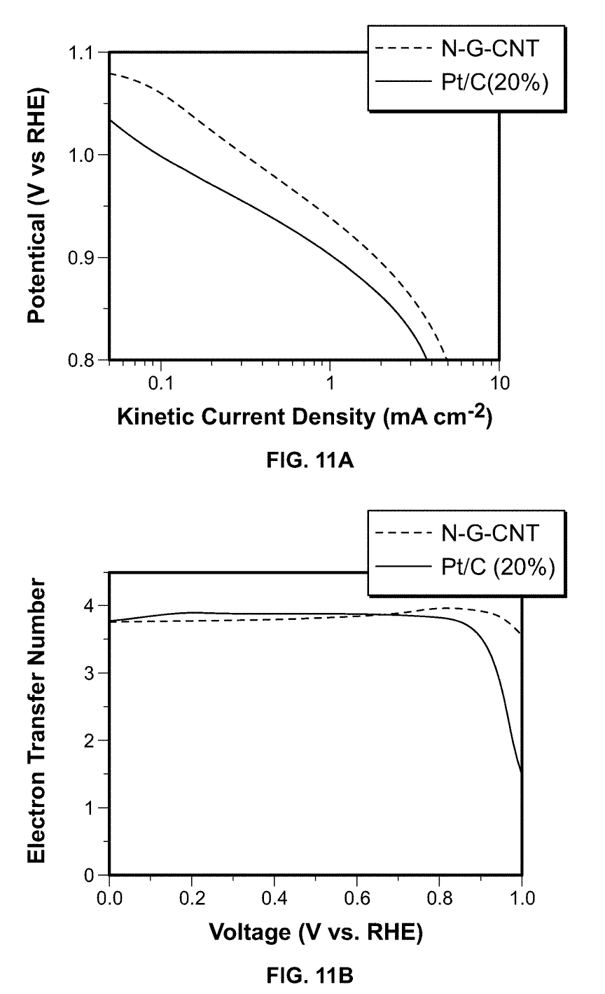

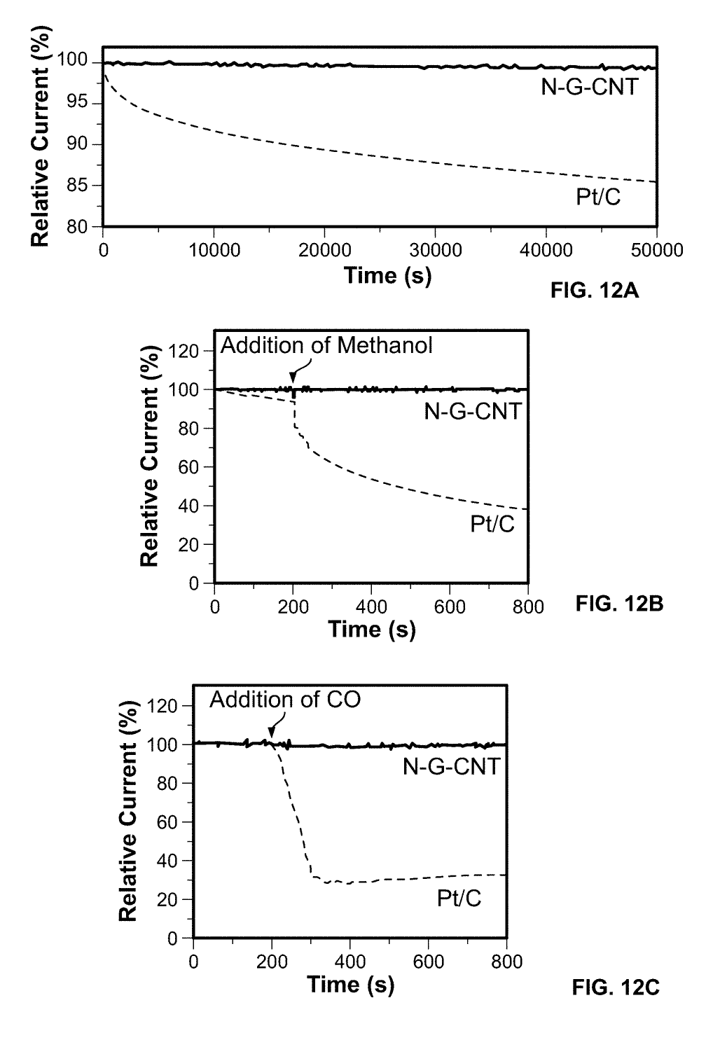

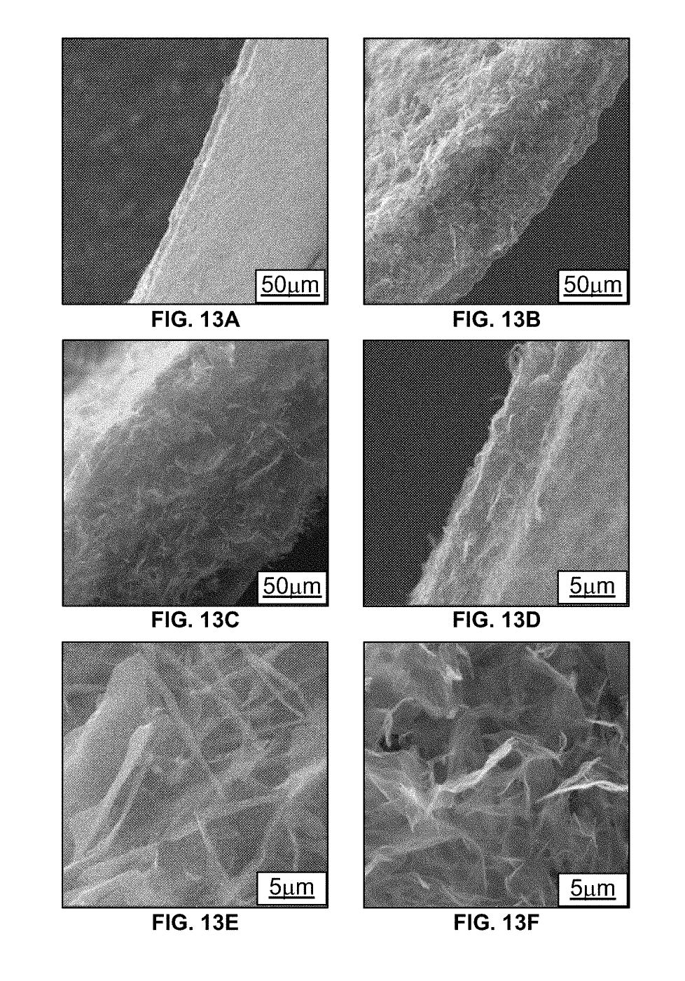

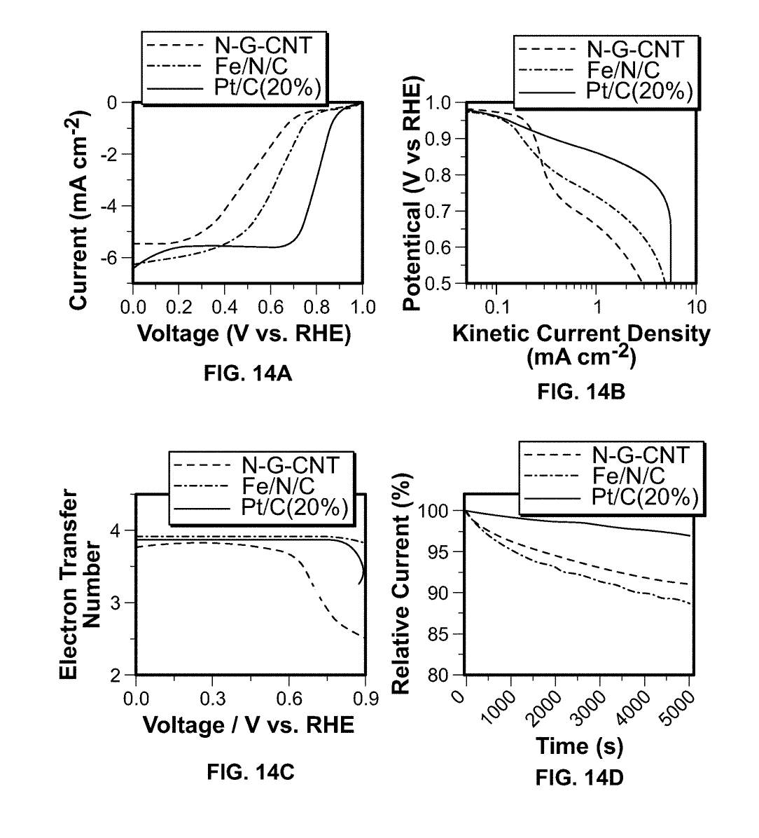

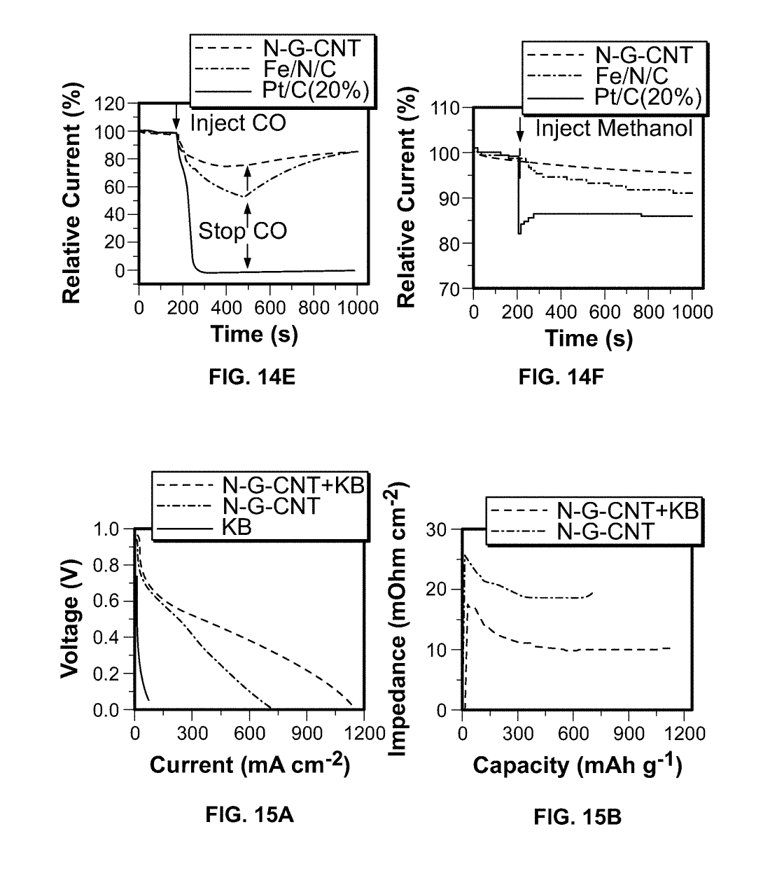

Prior to the single cell performance evaluation, the RDE and RRDE tests for the newly-developed N-G-CNT metal-free catalyst were carried out in a three-electrode electrochemical cell. FIG. 3A reproduces typical cyclic voltammetric (CV) curves of the N-G-CNT, showing a large cathodic peak at 0.8 V in O₂-saturated 0.1 M KOH solution, but not N₂-saturated electrolyte. The onset potential of the N-G-CNT is as high as 1.08 V; nearly 80 mV higher than that of Pt/C (FIG. 3B). Half-wave potential of the N-G-CNT is 0.87 V; 30 mV higher than that of Pt/C. Clearly, therefore, the N-G-CNT shows excellent electrocatalytic performance in 0.1 M KOH, even better than the commercial Pt/C electrode (C2-20, 20% platinum on Vulcan XC-72R; E-TEK), via a one-step 4e⁻ ORR process (FIGS. 11A-11B) with a better stability as well as a higher tolerance to MeOH-crossover and CO-poisoning effects than the Pt catalyst (FIGS. 12A-12C). It is believed that these results are the highest records for metal-free graphene and CNT ORR catalysts. The N-G-CNT composite also exhibited much better ORR performance than that of N-CNT and N-G catalysts in both the alkaline (FIG. 3C) and acidic media (FIG. 3D) due to its unique foam-like 3D architecture formed in the thin composite layer on the RDE electrode even without the addition of carbon black in the absence of mechanical compression (FIGS. 13A-13F, vide infra) as 3D carbon networks have been previously demonstrated to facilitate electrocatalytic activities (31, 43). More detailed ORR performance of the N-G-CNT in acidic media with respect to Fe/N/C and Pt/C can be found in FIGS. 14A-14F.

The above results indicate that N-G-CNT holds great potential for oxygen reduction in practical fuel cells. Therefore, the performance evaluation on MEAs based on the N-G-CNT in a 5-cm² PEM fuel cell with pure H₂/O₂ as fuel gases at 80° C. was carried out. At a typical catalyst loading of 2 mg cm⁻² (11-14, 44), the cell limiting current was as low as 700 mA cm⁻², though the cell OCV reached 0.97 V (FIG. 15A). The addition of carbon black (KB, 2 mg cm⁻²) into the N-G-CNT catalyst layer in the MEA caused ˜85% improvement on the delivered current density at low voltage range (<0.4 V), although KB itself had negligible electrocatalytic activity (FIG. 15A). The above observed enhancement in the current output can be attributed to the KB-induced porous-network formation to enhance the O₂ diffusion (FIGS. 2D, 2G and 10F) as the porosity seen in FIG. 13F for the as-cast N-G-CNT single electrode has been significantly reduced within the corresponding MEA (FIG. 10C) prepared under mechanical pressing. The improved electrocatalytic performance was also supported by the reduced cell impedance for the N-G-CNT+KB with respect to its N-G-CNT counterpart (FIG. 15B).

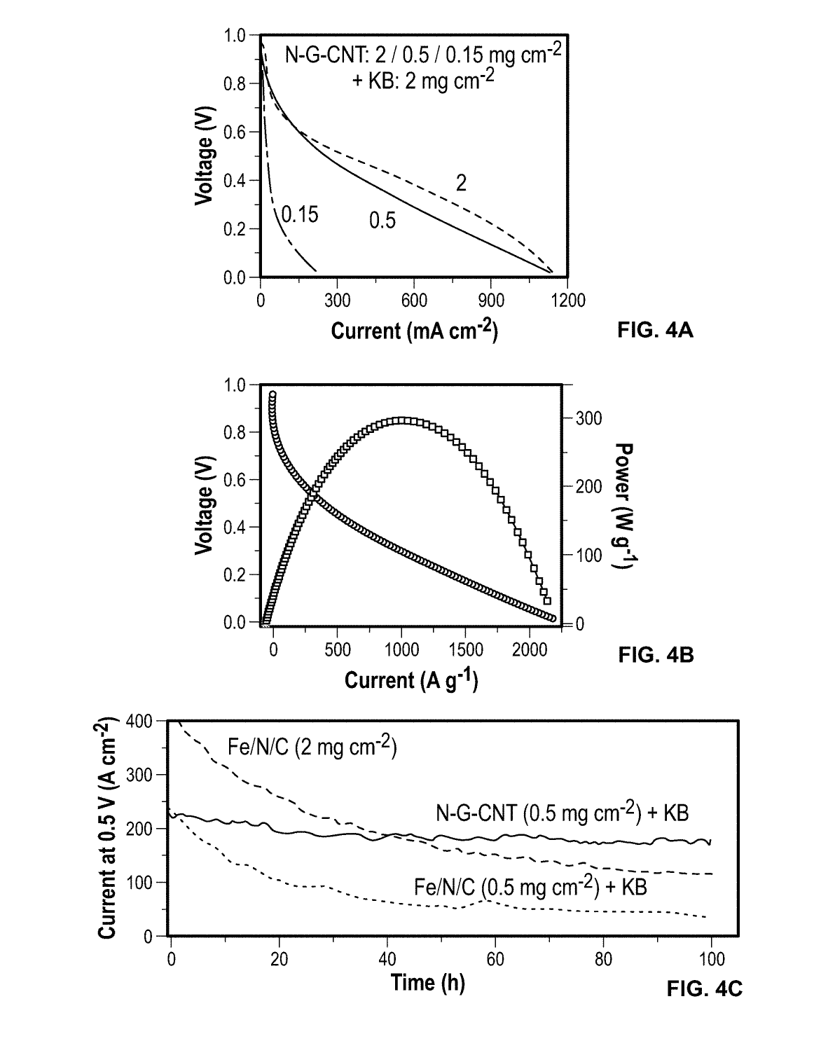

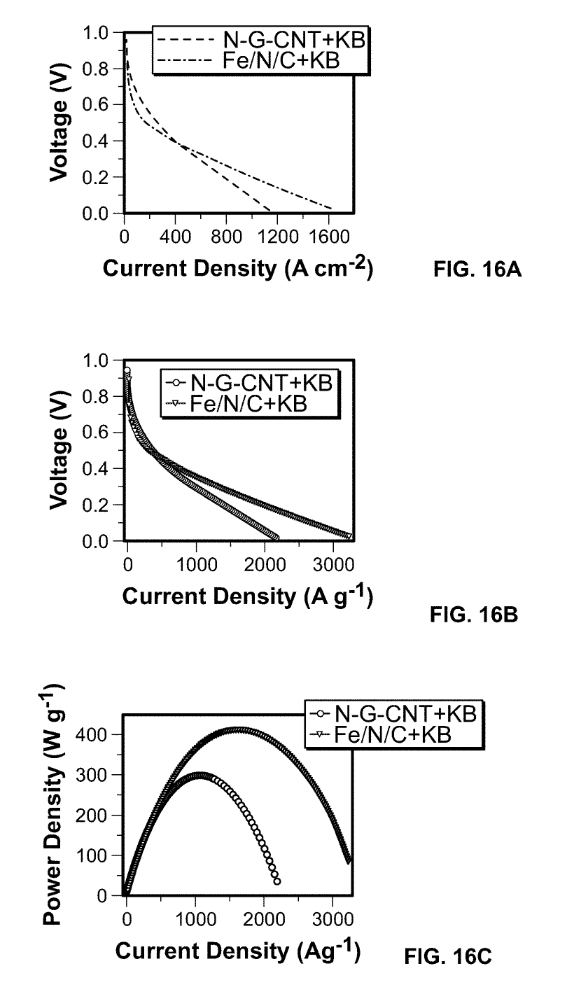

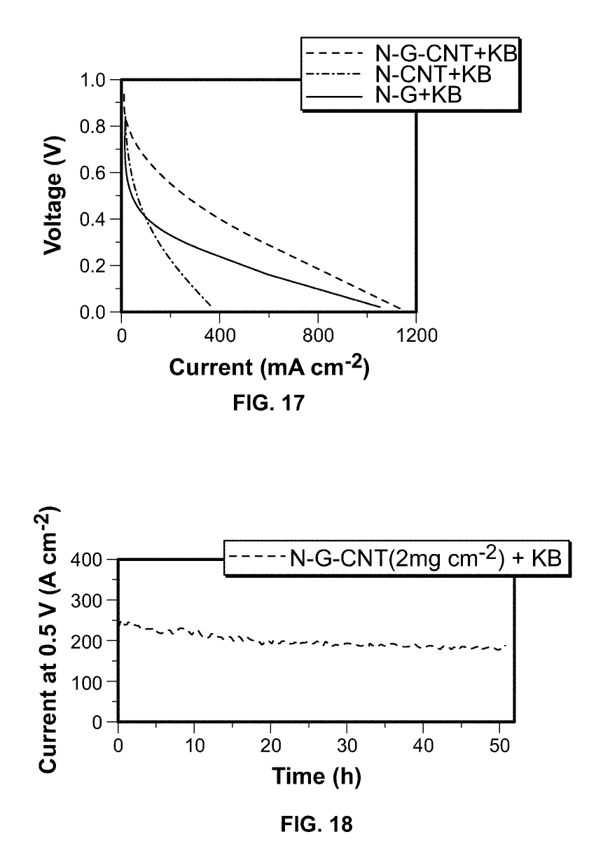

The cell performances at the N-G-CNT loading of 0.5 and 2 mg cm⁻² plus 2 mg cm⁻² KB are comparable (FIG. 4A), indicating dramatic activity suppression at the high catalyst loading even with carbon black dispersing. When the catalyst loading was further reduced to 0.15 mg cm⁻², however, the catalytic sites in the cathode were not sufficient to support a normal polarization curve. FIG. 4B shows the gravimetric polarization and power density curves for the N-G-CNT in the presence of carbon black (N-G-CNT:KB:Nafion=0.5:2:2.5 mg cm⁻²), from which a current of 30 A g⁻¹ @ 0.8 V, a limiting current of 2000 A g⁻¹@0.1 V, and a peak power density of 300 W g⁻¹ were obtained. Although metal-free catalysts usually exhibited a lower catalytic activity than that of NPMCs in RDE measurements (45), the observed gravimetric activity of the N-G-CNT+KB is comparable to high-performance Fe(Co)/N/C catalysts (Table 1, FIGS. 16A-16C), attributable to the full utilization of catalytic sites in the rationally-designed N-G-CNT+KB catalyst layer with the enhanced multichannel O₂ pathways (FIGS. 2D and 2G and FIG. 10F). The 3D multichannel porous structure, together with the unique materials hybridization, makes the PEM fuel cell based on the N-G-CNT+KB cathode to show a much better cell performance than its counterparts with the cathode made from either of the both constituent components (i.e., N-G+KB and N-CNT+KB, respectively) (FIG. 17).

The N-G-CNT+KB was further subjected to the durability test in the acidic PEM fuel cells at a constant voltage of 0.5 V with pure H₂/O₂ as fuel gases (FIG. 4C) in comparison with the Fe/N/C nonprecious metal catalyst. Like VA-NCNT, the N-G-CNT+KB exhibited an excellent stability with a relatively small current decay (˜20% decay over 100 hours, FIG. 4C). In contrast, the Fe/N/C catalyst showed an initial sharp current decay with a total about 75% decay over 100 hours at both the high (2 mg cm⁻²) and low loadings (0.5 mg cm⁻²). Excellent durabilities were observed for the N-G-CNT+KB catalyst at both low and high loadings (FIG. 4C and FIG. 18).

The RDE test for the newly-developed N-doped graphene and carbon nanotube (N-G-CNT) composite metal-free catalyst in a three-electrode electrochemical cell in acidic media was carried out prior to the single cell performance evaluation (FIGS. 14A-14F). Although electrocatalytically less active (onset potential 0.8 V and half-wave potential 0.5 V, electron transfer number 3.7) than Pt/C and Fe/N/C catalysts based on the LSV curves (FIGS. 14A and 14C), N-G-CNT presents a better durability than Fe/N/C in the acidic environment with 9% current decay in 5000 s at 0.5 V (vs. RHE) (FIG. 14D). More importantly, metal-free catalyst N-G-CNT shows better tolerances to CO than Fe/N/C that had 30% current decay in 200 s with the presence of CO, and Pt/C that lost all the activity and could not revive even after the removal of CO (FIG. 14E). In addition, N-G-CNT is almost inert to methanol while Fe/N/C and Pt/C were seriously deactivated with the presence of methanol in the acidic electrolyte (FIG. 14F), indicating a very promising utilization of metal-free catalysts as the cathode in alcohol fuel cells.

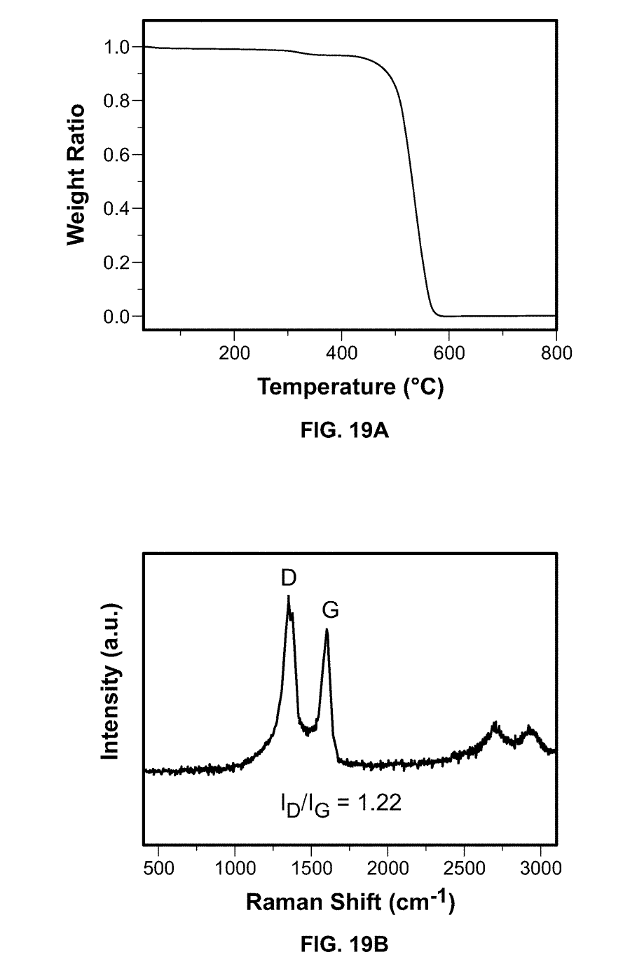

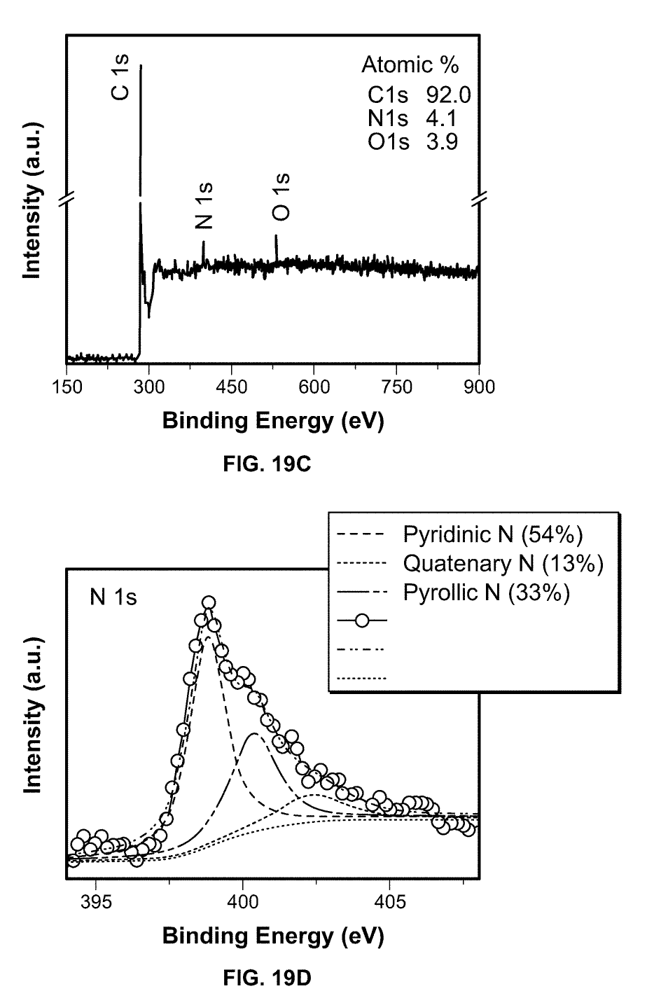

The fast performance drop at the first twenty hours for the Fe/N/C catalyst was typical for NPMCs, due to detrimental effects of the acidic and strong reduction environments on the metal active centers at the PEMFC cathode. Since the N-G-CNT+KB catalytic sites are free from metal nanoparticle (FIG. 19A-19D), no significant acidic corrosion is envisioned for the carbon electrode as carbon is much more anti-corrosive to acids than most transition metals. Therefore, the observed excellent stabilities for both the N-doped graphene, carbon nanotube and carbon black (N-G-CNT+KB) and VA-N-CNT cathodes in PEM fuel cells (FIGS. 1D, 4C and 18) should be an important intrinsic character for the carbon-based metal-free catalysts, facilitating them for a large variety of practical applications. These results clearly show great potential for carbon-based metal-free catalysts to be used as low-cost, efficient, and durable ORR catalysts in practical PEM fuel cells. Furthermore, the VA-NCNT and N-G-CNT+KB catalysts used in this study shared similar features in that N-doped carbon nanomaterials were used for the high ORR electrocatalytic activities, and that the large-surface-area porous structures were rationally designed for enhanced electrolyte/reactant diffusion. The methodology developed in the present study can be regarded as a general approach for the development of a large variety of high-performance, low-cost, metal-free catalysts for various practical energy devices, particularly in PEM fuel cells.

Materials and Methods

VA-NCNT was synthesized by pyrolysis of iron(II) phthalocyanine according to our previously published procedures (1). N-G-CNT composite was synthesized by sequentially combining a modified Hummers' method for the graphene oxide fabrication (31), a freeze drying a mixture of graphene oxide (GO) and oxidized CNT, followed by annealing at 800° C. in NH₃ for 3 hours. The transition metal Fe derived control sample (Fe/N/C) was synthesized according to literatures (11, 46). Specifically, 100 mg Zeolitic imidazolate frameworks (ZIF8) together with 10 mg tris(1, 10-phenanthroline) iron(II) perchlorate ion were ball-milled for one hour, heated in Ar at 1000° C. for 1 hour, and then at 900° C. under NH₃ for 15 minutes.

The electrochemical performances of the above ORR catalysts were characterized through (1) half cell tests in 0.1 M KOH or 0.1 M HClO₄ electrolytes by a rotating disc electrode method; (2) single cell tests with a 5-cm² membrane electrode assembly (MEA) and pure H₂/O₂ as fuels at 80° C., 100% relative humidity, and 2 bar back pressure. Detailed electrode fabrication and test processes are described below. Morphology and composition characterization of the materials is also described below.

Synthesis of Vertically-Aligned Nitrogen Doped CNT (VA-NCNT), Nitrogen Doped Graphene (N-G), CNT (N-CNT) and their Composite (N-G-CNT)

VA-NCNT was synthesized by pyrolysis of iron(II) phthalocyanine according to our previously published procedures (1). The N-G-CNT composite and its component N-G and N-CNT were synthesized according to the following procedures.

Graphene oxide, the precursor of N-G, was prepared by modified Hummers' method (31). Specifically, graphite flakes (3.0 g, purchased from Alfa Aesar) were added into the mixture of concentrated H₂SO₄ (70 mL) and NaNO₃ (1.5 g) in an ice bath. Thereafter, KMnO₄ (9.0 g) was added into the mixture, followed by stirring at 35° C. for 48 hours. Deionized water (150 mL) was added slowly into the mixture and then they were together poured into a beaker containing 500 mL deionized water and 15 mL 30% H₂O₂. Then, the solid in the mixture was recovered by filtration and washed with HCl (1 M) and deionized water. The solid was added to 300 mL water and sonicated for 1 hour for exfoliation of graphene oxide. The resultant graphene oxide was collected through filtration and washed copiously with deionized water. Typically, 40 mL of graphene oxide solution (2.5 mg mL⁻¹) was freeze-dried to obtain the GO foam. N-G foam was prepared by annealing the freeze-dried GO foams in a horizontal quartz tube in a tube furnace under ammonia gas (100 mL min⁻¹) at 800° C. for 3 hours.

The commercially available multiwall carbon nanotubes (MWCNTs, Baytubes C 150 HP, Bayer MaterialScience) were first purified in 1 M HCl at 60° C. for one week to remove the residual metal. The acid treated MWCNTs were then washed thoroughly with deionized water and dried in vacuum. 200 mg MWCNTs were oxidized in 200 mL acid mixture (concentrated H₂SO₄ (90%)/HNO₃ (70%)=3:1) at 60° C. for 3 hours with vigorous stirring. After oxidization, the oxidized MWCNTs (Ox-MWCNTs) were recovered by filtration and purified by deionized water and dialysis for 6 days. The metal-free Ox-MWCNTs suspension were then freeze-dried and annealed in NH₃ for 3 hours at 800° C. to produce N-CNT.

For the preparation of the N-G-CNT composite, a total of 250 mg GO and Ox-MWCNT (with a weight ratio of 1:1) were stirred in 100 mL deionized water for 2 hours and sonicated for another 1 hour to form a uniform suspension mixture. Then, the GO/Ox-MWCNT suspension was freeze-dried and annealed at 800° C. in NH₃ for 3 hours. BET surface area of N-G-CNT, N-G and N-CNT after the heat treatment for 3 hours is 422, 432 and 438 m² g⁻¹, respectively.

The transition metal Fe derived control sample (Fe/N/C) was synthesized according to literatures (11, 46). Specifically, ball milling on 100 mg Zeolitic imidazolate frameworks (ZIF8) together with 10 mg tris(1, 10-phenanthroline) iron(II) perchlorate ion for one hour, which was subsequently heated in Ar at 1000° C. for 1 hour, and then at 900° C. under NH₃ for 15 minutes was performed.

### MEA Fabrication and Fuel Cell Tests

As shown in FIG. 1A, VA-NCNT@Si was electrochemically oxidized in H₂SO₄ to remove Fe residues, if any (1). Then, the purified VA-NCNT array was etched off from Si wafer in aqueous 10 wt. % HF, and rinsed with deionized water. The free-standing VA-NCNT array thus prepared was then transferred onto a piece of carbon paper with a preloaded micro-porous layer as gas diffusion layer (GDL) (ElectroChem Inc, Carbon Micro-porous Layer (CMPL)) to support the NCNT array. Thereafter, a predetermined amount of Nafion (Nafion® perfluorinated resin, DuPont) solution (0.5%, 200 mL) was dropped onto the VA-NCNT array and automatically dispersed into the array. After drying at 80° C. for one hour in vacuum with a piece of mirror-like stainless steel covering on the top of the array to prevent it from curling during drying, the cathode (VA-NCNT array catalyst layer with the GDL) was ready for MEA fabrication.

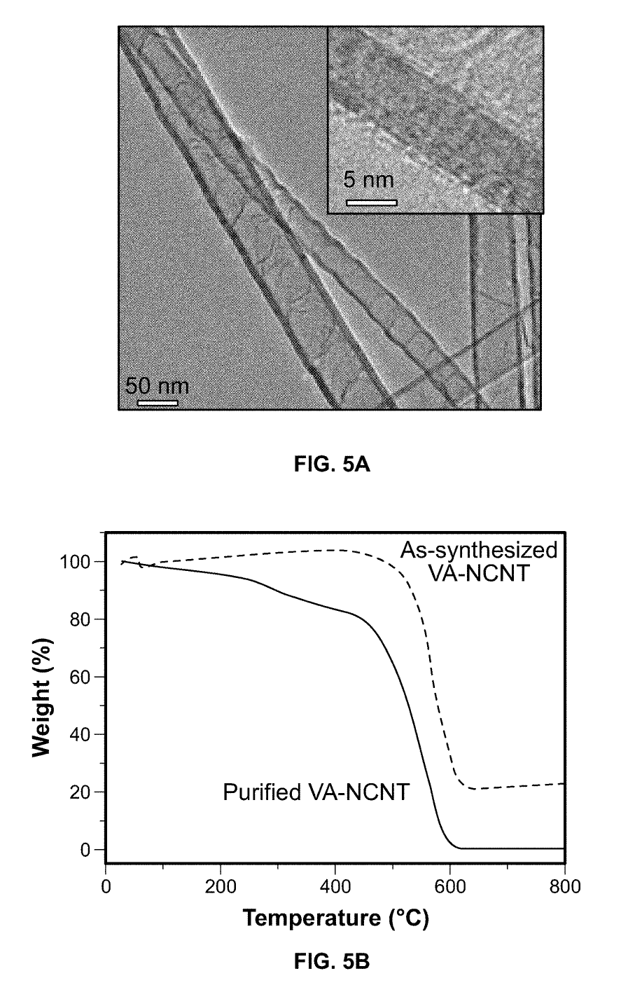

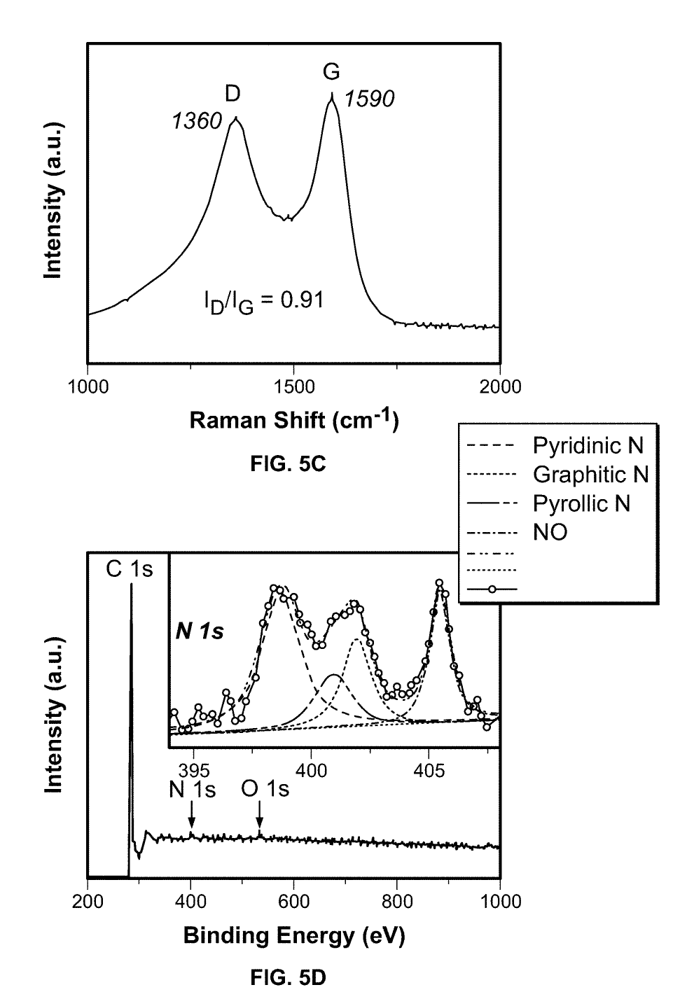

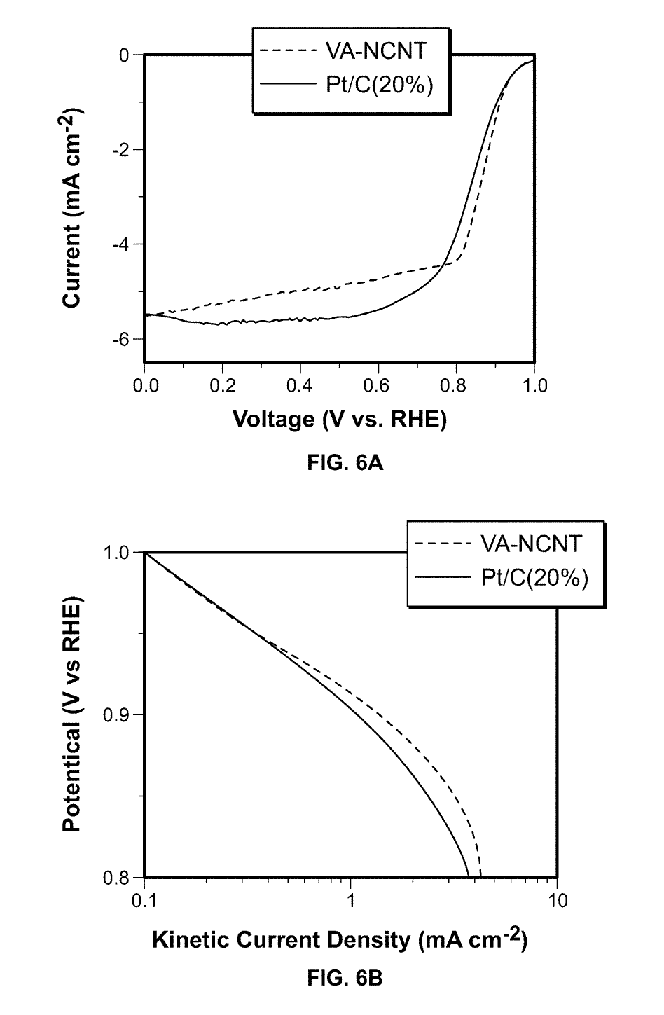

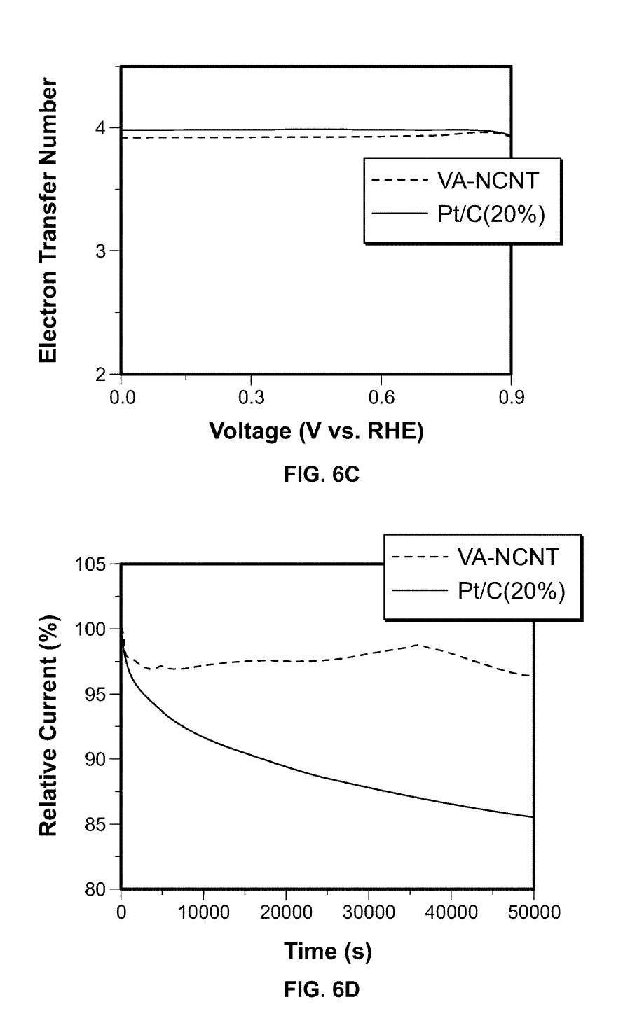

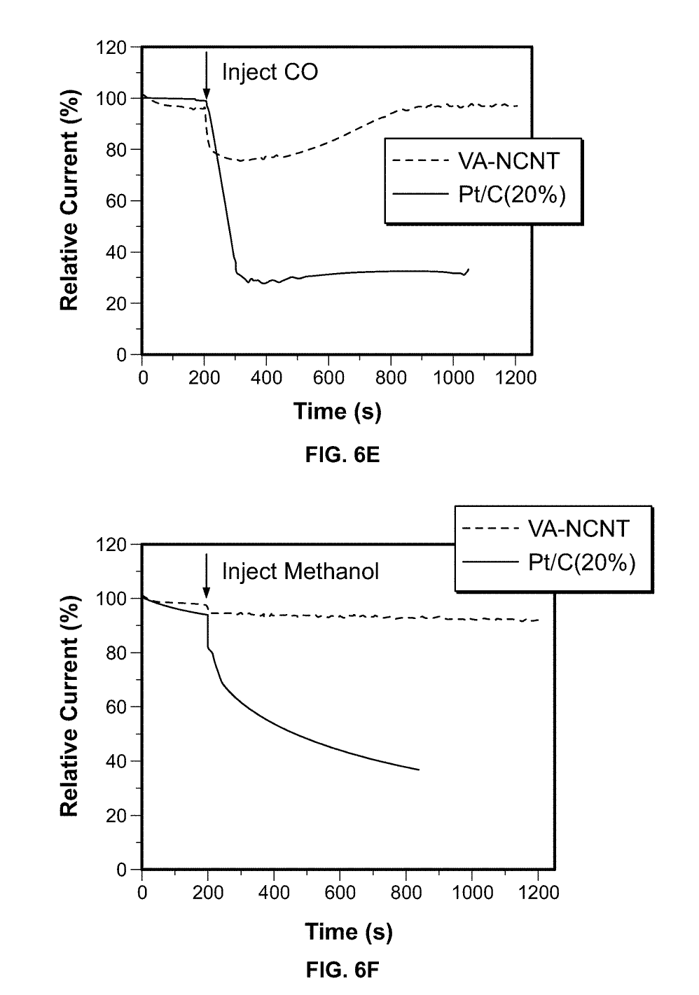

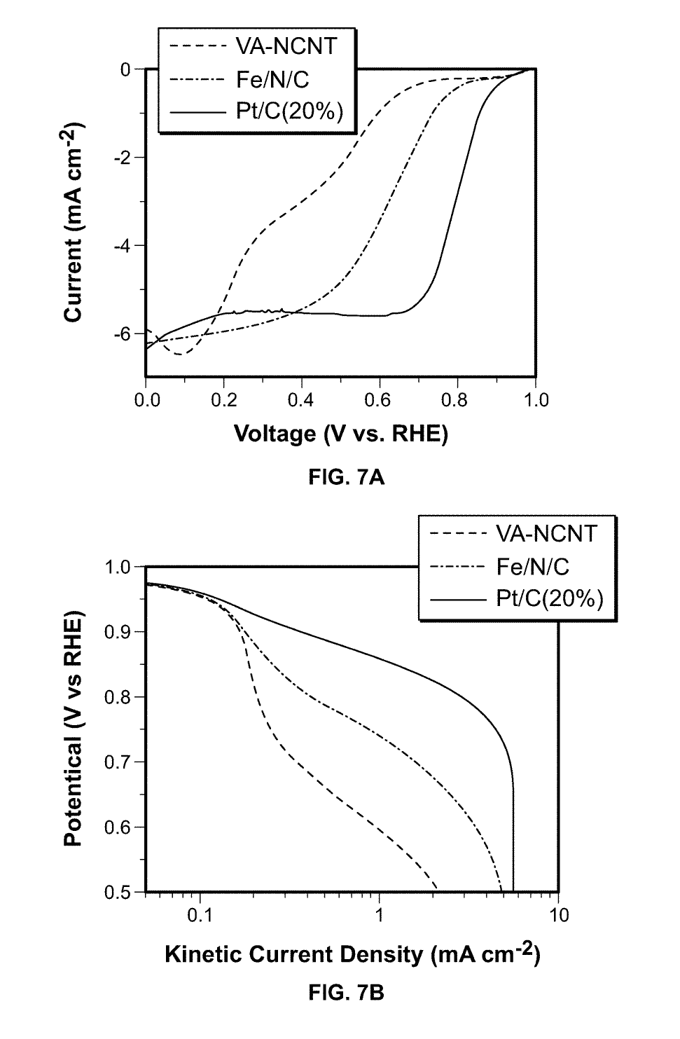

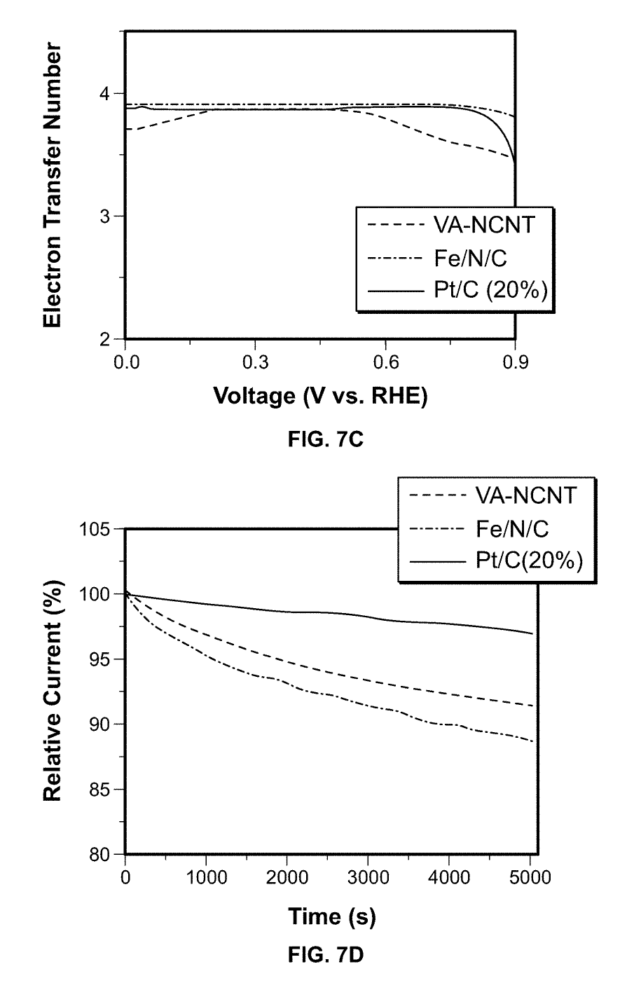

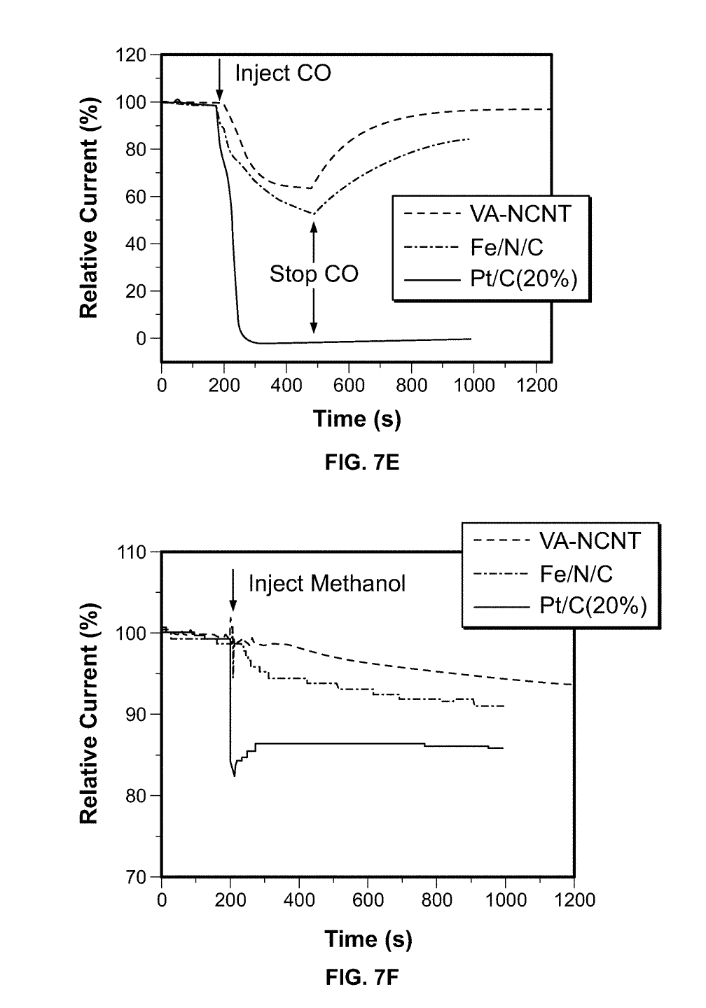

For N-G-CNT based cathodes, catalyst inks were prepared by mixing catalysts with Nafion resin (with or without Ketjenblack® EC-600JD, primary particle radius 34 nm, BET surface area 1270 m²g⁻¹, Akzo Nobel Surface Chemistry LLC.) at ionomer/(catalyst+KB) ratio=1/1, and painted onto the GDL as the cathode. For example, 2.5 mg N-G-CNT was mixed with 10 mg Ketjenblack and 375 mg Nafion solution (5%) in 1.5 mL deionized water and isopropanol mixture (volume ratio=1:2). The ink was sonicated for 10 minutes and stirred overnight, and then painted onto 5 cm² GDL as the cathode. The metal-free nature of the N-CNT and N-G-CNT was clearly evident by the XPS and TGA measurements shown in FIGS. 5A-5D and FIGS. 19A-19D.

The anode was Pt/C (20%) with an excessive Pt loading of 0.4 mg cm⁻² to ensure sufficient proton supply from the anode. A pair of cathode and anode was hot pressed onto two sides of a N211 (Nafion®, Du Pont) membrane at 130° C. for 0.5 min under pressure 20 lb cm⁻² firstly, then under pressure 60 lb cm⁻² for another 1.5 min (FIGS. 8A-8C and 10A-10F). The membrane electrode assembly (MEA) thus produced was tested in a 5 cm² PEM fuel cell (Scribner Inc.) at 80° C. with 100% relative humidity (RH) and back pressure 2 bars. Pure H₂ (300 mL min⁻¹) and O₂ (500 mL min⁻¹) were used as anode and cathode fuels, respectively. Durability was measured at a constant voltage mode at 0.5 V or 0.4 V, or a scanning voltage model from OCV to 0.1 V at a rate of 10 mV s⁻¹ with H₂ (100 mL min⁻¹) and O₂ (100 mL min⁻¹).

### Characterization of the N-G-CNT on Rotating Disc Electrode

The measurements were performed using a potentiostat (CHI 760D, CH Instrument) with a typical three-electrode cell at room temperature (˜25° C.). A platinum wire was used as counter electrode. A silver/silver chloride electrode (Ag/AgCl) and saturated calomel electrode (SCE) were used as reference electrodes in O₂ saturated 0.1 M HClO₄ and 0.1 M KOH electrolytes, respectively. For the working electrode, special attention was paid to make sure that the N-G-CNT foam was not broken into fine powder in order to make a porous catalyst layer. In order to do so, 1 mg electrocatalysts was dispersed in 0.4 mL water/isopropanol (1:1) with mild sonicating for 30 seconds to make a uniform ink. 15 μL, ink was loaded on a glass-carbon electrode, and 10 μL Nafion solution (0.05%) was then loaded on the electrode. The ORR activity of the electrocatalysts was evaluated by the linear sweep voltammetry (LSV) technique on a rotating disk electrode (RDE) and rotating ring-disk electrode (RRDE) test. Methanol, CO tolerance test and durability test (50000 s) on N-G-CNT and Pt/C were conducted by the chronoamperometric technique at −0.3 V (vs. SCE) in O₂ saturated 0.1 M KOH.

### Morphology, Composition Characterization

The morphology of VA-NCNT, N-G, N-CNT, and N-G-CNT with and without the addition of Ketjenblack® EC-600JD was investigated by scanning electron microscopy (Tescan Vega3) and transmission electron microscopy (FEI Tecnai TF20 FEG). Brunauer, Emmett and Teller (BET) surface area and pore size distribution were measured by a TriStar II, Micromertics®. For the blank GDL sample, a piece of 5 cm² GDL was brushed with 250 mg Nafion solution (1%) to mimic the real electrode where GDL would be immersed by Nafion solution during brushing catalyst inks onto the GDL. To mimic the real electrode porosity in the MEAs, all the electrode samples, including blank GDL, were hot pressed at the same condition as hot pressing a MEA except without the Nafion membrane and the anode. Raman spectra were measured on a Renishaw Raman spectrometer using 514 nm laser. Thermogravimetric analysis was performed on a thermogravimetric analyzer (TGA, TA instrument, Q50) in air condition with a heating rate of 10° C. min⁻¹. X-ray photoelectron spectroscopic (XPS) measurements were performed on a VG Microtech ESCA 2000.

Embodiments of the technology have been described above and modifications and alterations may occur to others upon the reading and understanding of this specification. The claims as follows are intended to include all modifications and alterations insofar as they come within the scope of the claims or the equivalent thereof.

1. A membrane electrode assembly comprising:
a polymer membrane electrolyte layer having a first face and a second face, an anode layer disposed on a first face of the polymer membrane electrolyte layer, and
a cathode layer disposed on the second face of the polymer membrane electrolyte layer, the cathode layer comprising a catalyst material comprising a metal-free, heteroatom doped carbon based material.

2. The membrane electrode assembly of claim 1, wherein the heteroatom doped carbon based material comprises heteroatom doped carbon nanotubes.

3. The membrane electrode assembly of claim 2, wherein the heteroatom is chosen from nitrogen, boron, phosphorous, sulfur, iodine, bromine, chlorine, fluorine, a defect, or a combination of two or more thereof.

4. The membrane electrode assembly of claim 2, wherein the heteroatom is nitrogen.

5. The membrane electrode assembly of claim 2, wherein the heteroatom doped carbon nanotubes are nitrogen-doped vertically aligned carbon nanotubes.

6. The membrane electrode assembly of claim 1, wherein the heteroatom doped carbon based material comprises heteroatom doped graphitic material.

7. The membrane electrode assembly of claim 6, wherein the graphitic material is chosen from graphite, graphene, highly ordered pyrolytic graphite (HOPG), fullerene, or a combination of two or more thereof.

8. The membrane electrode assembly of claim 6, wherein the heteroatom doped carbon based material comprises a composite of heteroatom doped graphene and carbon nanotubes.

9. The membrane electrode assembly of claim 6, wherein the heteroatom is chosen from nitrogen, boron, phosphorous, sulfur, iodine, bromine, chlorine, fluorine, a defect, or a combination of two or more thereof.

10. The membrane electrode assembly of claim 9, wherein the heteroatom is nitrogen.

11. The membrane electrode assembly of claim 8, wherein the carbon nanotubes are chosen from non-aligned carbon nanotubes, vertically aligned carbon nanotubes, or a combination thereof.

12. The membrane electrode assembly of claim 6, wherein the heteroatom doped carbon based material further comprises conductive carbon particles.

13. The membrane electrode assembly of claim 12, wherein the conductive carbon particles are chosen from ketjen black, acetylene black, oil furnace black, thermal black, channel black, or a combination of two or more thereof.

14. The membrane electrode assembly of claim 1 comprising a first gas diffusion layer disposed on the anode layer, and a second gas diffusion layer disposed on the cathode layer.

15. An electrochemical device comprising a fuel cell comprising the membrane electrode assembly of claim 1.

16. The electrochemical device of claim 14, wherein the device comprises a plurality of the fuel cells connected in electrical series.

17. The electrochemical device of claim 15 comprising at least one bipolar plate disposed between adjacent fuel cells, the bipolar plate having oxygen flow channels and hydrogen flow channels.
